(19) United States
(12) Patent Application Publication
(10) Pub. No.: US 2023/0254449 A1
(43) Pub. Date: Aug. 10, 2023

(54) INFORMATION PROCESSING SYSTEM, INFORMATION PROCESSING METHOD, INFORMATION PROCESSING PROGRAM

(71) Applicant: GREE, Inc., Tokyo (JP)

(72) Inventors: Akihiko SHIRAI, Kanagawa (JP); Tomosuke NAKANO, Kanagawa (JP); Takanori HORIBE, Kanagawa (JP); Yusuke YAMAZAKI, Tokyo (JP)

(73) Assignee: GREE, Inc., Tokyo (JP)

(21) Appl. No.: 18/147,205

(22) Filed: Dec. 28, 2022

(30) Foreign Application Priority Data
Feb. 8, 2022 (JP) 2022-018283

(51) Int. Cl. H04N 7/15

(52) U.S. Cl. CPC H04N 7/157

(57) ABSTRACT

An information processing system operable to effectively promote a conversation, including starting and activating a conversation between avatars in the virtual space, for example by generating a terminal output image showing a virtual space including an avatar associated with each user; outputting text information or voice information perceptible by each user together with the terminal output image based on a conversation-related input from each user associated with an avatar in the virtual space; specifying, for a conversation established between users based on the text information or the voice information, a theme of the conversation based on the conversation-related input; and performing theme information output processing for making theme information indicating the previously-specified theme of the conversation be included in the terminal output image.

### FIELD

The present disclosure relates to an information processing system, an information processing method, and an information processing program.

### BACKGROUND

A technique for changing the arrangement of virtual characters (avatars) in the virtual space according to the occurrence of conversation is known.

### SUMMARY

Such techniques for changing the arrangement of virtual characters, however, may be inadequate for providing the desired user experience, because such techniques may make it difficult to effectively promote a conversation, including starting and activating a conversation between avatars in the virtual space.

Therefore, it is an object of the disclosure to effectively promote a conversation, including starting and activating a conversation between avatars in the virtual space.

According to an aspect of the disclosure, an information processing system may include: an image generation unit that generates a terminal output image showing a virtual space including an avatar associated with each user; an information output unit that outputs text information or voice information viewable or perceptible by each user together with the terminal output image based on a conversation-related input from each user associated with an avatar in the virtual space; a theme specifying unit that specifies, for a conversation established between users based on the text information or the voice information output from the information output unit, a theme of the conversation based on the conversation-related input; and a theme information output processing unit that performs theme information output processing for making theme information indicating the theme of the conversation specified by the theme specifying unit be included in the terminal output image. It may be contemplated that, for the purposes of the disclosure, output information being described as “viewable” or as “perceptible” encompasses information that, in various exemplary embodiments, may be conveyed to the user by one or more of the user's senses, including visual information that may be seen by the user, auditory information that may be heard by the user, a combination of visual and auditory information that may be both seen and heard by the user, and so forth, such as may be desired.

According to an aspect of the disclosure, it is possible to effectively promote a conversation, including starting and activating a conversation between avatars in the virtual space. In addition, according to another aspect of the disclosure, it is possible to simultaneously achieve a reduction in the amount of data volume or processing load that may be used for activation of communication. In addition, according to still another aspect of the disclosure, it is possible to improve usability and reduce the processing load by reducing the number of user operations. In addition, according to further still another aspect of the disclosure, it is possible to effectively display necessary information for the user.

### BRIEF DESCRIPTION OF THE DRAWINGS

FIG. 1 is a block diagram of a virtual reality generation system according to an exemplary embodiment;

FIG. 2 is an explanatory diagram of an exemplary terminal image that can be visually recognized through a head-mounted display;

FIG. 3 is an exemplary conceptual diagram of one talk room in the virtual space;

FIG. 4 is an exemplary conceptual diagram of another talk room in the virtual space;

FIG. 5 is an explanatory diagram of an example of a virtual space that can be generated by the virtual reality generation system;

FIG. 6 is an explanatory diagram of example regions with different attributes around a moderator avatar in the virtual space;

FIG. 7 is an explanatory diagram of an example of how a moderator avatar (talk room) is generated based on a predetermined talk theme;

FIG. 8 is an explanatory diagram of another example of how a moderator avatar (talk room) is generated based on a predetermined talk theme;

FIG. 9 is an explanatory diagram of an overview of an exemplary talk room formed based on a predetermined talk theme;

FIG. 10 is an explanatory diagram (case 1) of various example forms of a talk room;

FIG. 11 is an explanatory diagram (case 2) of various example forms of a talk room;

FIG. 12 is an explanatory diagram of an arrangement example of talk rooms according to the details (hierarchy) of a talk theme;

FIG. 13 is an explanatory diagram showing an example of a talk room selection screen for viewing on a smartphone or the like;

FIG. 14A is a diagram showing an example of a talk room image (terminal image) for a participant side user when the participant side user enters one talk room through the talk room selection screen shown in FIG. 13;

FIG. 14B is a diagram showing another example of the talk room image for a participant side user;

FIG. 14C is a diagram showing still another example of the talk room image for a participant side user;

FIG. 15 is an explanatory diagram illustrating an example of a talk room selection screen for viewing on a head-mounted display;

FIG. 16 is a schematic block diagram showing functions of a server apparatus related to the talk theme described above;

FIG. 17 is an explanatory diagram showing an example of data in a talk history storage unit;

FIG. 18 is an explanatory diagram showing an example of data in a talk situation storage unit;

FIG. 19 is an explanatory diagram showing an example of data in a user information storage unit;

FIG. 20 is an explanatory diagram of various tables;

FIG. 21 is an explanatory diagram showing an example of data in an avatar information storage unit;

FIG. 22 is an explanatory diagram of the hierarchical structure of talk themes;

FIG. 23 is a schematic block diagram showing functions of a terminal apparatus related to the talk theme;

FIG. 24 is an explanatory diagram showing an example of the effect of output by an activity level output unit;

FIG. 25 is a diagram showing an example of a user interface suitable for a virtual space where an avatar can freely move around;

FIG. 26 is an explanatory diagram of an exemplary part direction operation input by a gesture;

FIG. 27 is a diagram showing an example of a terminal image for a user in order to explain an example of guidance processing;

FIG. 28 is an explanatory diagram of an exemplary flow of operations from the generation of one talk room to the end of distribution; and

FIG. 29 is a flowchart showing an example of an operation in the virtual reality generation system shown in FIG. 1.

### DETAILED DESCRIPTION

Hereinafter, various exemplary embodiments will be described with reference to the diagrams.

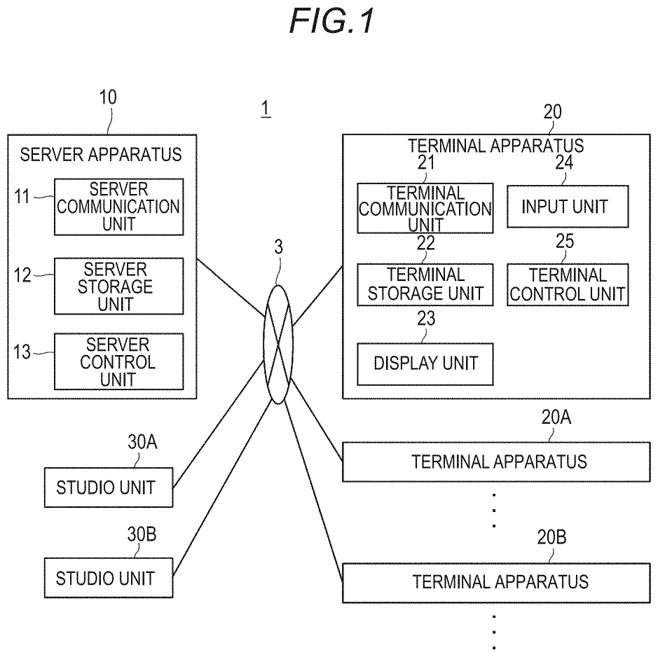

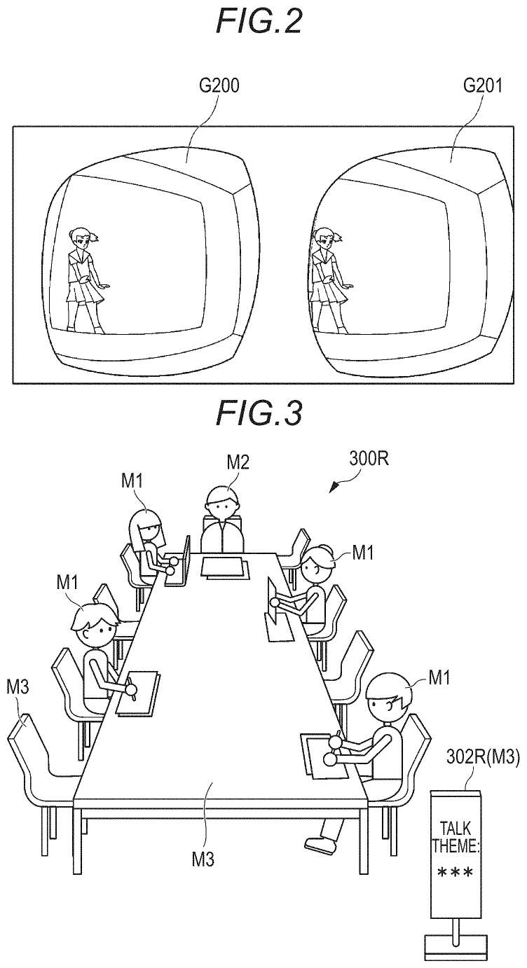

An overview of a virtual reality generation system 1 according to an embodiment of the invention will be described with reference to FIG. 1. FIG. 1 is a block diagram of the virtual reality generation system 1 according to the present exemplary embodiment. FIG. 2 is an explanatory diagram of an exemplary terminal image that can be visually recognized through a head-mounted display.

The virtual reality generation system 1 may include a server apparatus 10 and one or more terminal apparatuses 20. In FIG. 1, for the sake of convenience, three terminal apparatuses 20 are shown, but the number of terminal apparatuses 20 may be two or more.

The server apparatus 10 may be, for example, an information processing system such as a server managed by an administrator who provides one or more virtual realities. The terminal apparatus 20 may be an apparatus used by a user, such as a mobile phone, a smartphone, a tablet terminal, a personal computer (PC), a head-mounted display, or a game machine. A plurality of terminal apparatuses 20 can be connected to the server apparatus 10 through a network 3, typically in a different manner for each user.

The terminal apparatus 20 can execute a virtual reality application according to the present embodiment. The virtual reality application may be received by the terminal apparatus 20 from the server apparatus 10 or a predetermined application distribution server through the network 3, or may be stored in advance in a storage device provided in the terminal apparatus 20 or a storage medium such as memory card readable by the terminal apparatus 20. The server apparatus 10 and the terminal apparatus 20 may be communicably connected to each other through the network 3. For example, the server apparatus 10 and the terminal apparatus 20 may cooperate to perform various processes relevant to the virtual reality.

In the virtual reality generation system 1, users who use the system may be divided into the host side (content distribution side) and the participant side (content viewing side), or each user may use the system on an equal footing without distinguishing between the two. When the users are divided into the host side and the participant side, the terminal apparatuses 20 may include a host side (content distribution side) terminal apparatus 20A and a participant side (content viewing side) terminal apparatus 20B. When the users are not divided into the host side and the participant side, the terminal apparatuses 20 may not be divided into the host side terminal apparatus 20A and the participant side terminal apparatus 20B. In the following description, the host side terminal apparatus 20A and the participant side terminal apparatus 20B are described as separate terminal apparatuses, but the host side terminal apparatus 20A may be the participant side terminal apparatus 20B or vice versa. Hereinafter, when the terminal apparatus 20A and the terminal apparatus 20B are not particularly distinguished, the terminal apparatus 20A and the terminal apparatus 20B may simply be referred to as the “terminal apparatus 20”.

The respective terminal apparatuses 20 may be communicably connected to each other through the server apparatus 10. In the following description, “one terminal apparatus 20 transmits information to another terminal apparatus 20” may therefore mean “one terminal apparatus 20 transmits information to another terminal apparatus 20 through the server apparatus 10”. Similarly, “one terminal apparatus 20 receives information from another terminal apparatus 20” may therefore mean “one terminal apparatus 20 receives information from another terminal apparatus 20 through the server apparatus 10”. However, in a modification example, the respective terminal apparatuses 20 may be communicably connected to each other without going through the server apparatus 10.

In addition, the network 3 may include a wireless communication network, the Internet, a virtual private network (VPN), a wide area network (WAN), a wired network, or any combination thereof.

In the example shown in FIG. 1, the virtual reality generation system 1 may include studio units 30A and 30B. The studio units 30A and 30B are host side apparatuses, similarly to the host side terminal apparatus 20A. The studio units 30A and 30B can be arranged in studios, rooms, halls, and the like for content production.

Each studio unit 30 can have the same functions as the host side terminal apparatus 20A and/or the server apparatus 10. When distinguishing between the host side and the participant side, for the sake of simplicity, the following description will be focused on how the host side terminal apparatus 20A distributes various contents to the participant side terminal apparatus 20B through the server apparatus 10. However, instead of or in addition to this, the studio units 30A and 30B facing the host side users may have the same function as the host side terminal apparatus 20A to distribute various contents to the participant side terminal apparatus 20B through the server apparatus 10. In addition, in the modification example, the virtual reality generation system 1 may not include the studio units 30A and 30B.

In the following description, the virtual reality generation system 1 may implement an example of an information processing system, but each element of a specific terminal apparatus 20 (see terminal communication unit 21 to terminal control unit 25 in FIG. 1) may implement an example of the information processing system or a plurality of terminal apparatuses 20 may cooperate to implement an example of the information processing system. In addition, the server apparatus 10 may implement an example of the information processing system by itself, or the server apparatus 10 and one or more terminal apparatuses 20 may cooperate to implement an example of the information processing system.

Here, an overview of virtual reality according to the present embodiment will be described. An exemplary implementation of virtual reality according to the present embodiment may be, for example, virtual reality for any reality, such as education, travel, role-playing, simulation, and entertainment such as games and concerts, and virtual reality media, such as avatars, may likewise be used with the implementation of virtual reality. For example, the virtual reality according to the present embodiment may be realized by a three-dimensional virtual space, various virtual reality media appearing in the virtual space, and various contents provided in the virtual space.

Virtual reality media may be electronic data used in virtual reality, may be include arbitrary media such as cards, items, points, currency in service (or currency in virtual reality), tokens (for example, Non-Fungible Token (NFT)), tickets, characters, avatars, and parameters. In addition, the virtual reality media may be virtual reality related information such as level information, status information, parameter information (physical strength value, attack power, and the like), or ability information (skills, abilities, spells, jobs, and the like). In addition, the virtual reality medium may include electronic data that can be acquired, owned, used, managed, exchanged, combined, strengthened, sold, discarded, or donated by the user in the virtual reality, but the usage of the virtual reality medium is not limited to those described in the present specification.

In the present embodiment, when the users are divided into the host side and the participant side, the users may include a participant side user who views various contents and a host side user who distributes specific talk content (an example of predetermined digital content) to be described later through a moderator avatar M2 to be described later. When the users are not divided into the host side and the participant side, a plurality of equal users may be included.

In addition, the host side user, as a participant side user, can view specific talk content by another host side user, and conversely, the participant side user, as a host side user, can distribute specific talk content. However, in order to prevent complication of the following description, it is assumed that the participant side user is a participant side user at that time and the host side user is a host side user at that time. In addition, in the following description, when there is no particular distinction between the host side user and the participant side user, the host side user and the participant side user may simply be referred to as “users”. In addition, when the moderator avatar M2 and a participating avatar M1 related to the participant side user are not particularly distinguished, these may simply be referred to as “avatars”. In addition, in the following description, due to the nature of avatars, the user and the avatar may be treated as the same. Therefore, for example, “one avatar does XX” may be synonymous with “one user does XX”.

In addition, the avatar is typically in the form of a character having a front facing direction, and may be in the form of a person, an animal, or the like. Avatars can have various appearances (appearances when drawn) by being associated with various avatar items.

Each of the participant side user and the host side user may wear a wearable device on a part of his or her head or face to visually recognize the virtual space through the wearable device. In addition, the wearable device may be a head-mounted display or a glasses-type device. The glasses-type device may be so-called augmented reality (AR) glasses or mixed reality (MR) glasses. In any case, the wearable device may be separate from the terminal apparatus 20, or may realize some or all of the functions of the terminal apparatus 20. The terminal apparatus 20 may be realized by a head-mounted display.

Alternatively, the participant side user and the host side user may use a device having a screen, such as a smartphone or a personal computer, to visually recognize the virtual space through the display screen. In this case, the virtual space may be expressed by a substantially two-dimensional display.

In the following description, among various contents distributed by the server apparatus 10, specific talk contents that allow a conversation between users (between avatars) will be mainly described. In addition, in the following description, contents that are preferably viewed through a head-mounted display, a smartphone, or the like will be described.

The specific talk content by the host side user is user participation type talk content in which users other than the host side user can participate, and is video content involving conversations by a plurality of users through their respective avatars. The specific talk content by the host side user may be a type of content in which the host side user holds a conversation along a theme determined by the host side user. In addition, in the specific talk content by the host side user, the moderator avatar M2 related to the host side user, who changes the direction, location, movement, and the like according to the direction, location, movement, and the like of the host side user, may appear in the virtual space. In addition, the direction, location, and movement of the host side user are a concept including not only the direction, location, and movement of a part or entirety of the host side user's body, such as the face or hands, but also the direction, location, movement, and the like of the host side user's line of sight.

The specific talk content by the host side user may typically involve a conversation in any manner through the moderator avatar M2. For example, the specific talk content by the host side user may be related to chats, meetings, gatherings, conferences, and the like.

In addition, the specific talk content by the host side user may include a form of collaboration by two or more host side users. As a result, distribution in various modes may become possible, and interaction between the host side users may be promoted.

In addition, the server apparatus 10 can also distribute contents other than the specific talk content by the host side user. The type or number of contents provided by the server apparatus 10 (contents provided in virtual reality) is arbitrary. In the present embodiment, as an example, the content provided by the server apparatus 10 may include digital content such as various videos. The video may be real-time video, or may be non-real-time video. In addition, the video may be a video based on a real image, or may be a video based on computer graphics (CG). The video may be a video for providing information. In this case, the video may be related to information providing services of a specific genre (information providing services related to travel, housing, food, fashion, health, beauty, and the like), broadcast services by specific users (for example, YOUTUBE), and the like.

There are various modes of providing content in virtual reality, and a mode other than the mode of providing information by using the display function of the head-mounted display may be applied. For example, when the content is a video, the content may be provided by drawing the video on the display of a display device (virtual reality medium) in the virtual space. In addition, the display device in the virtual space may have an arbitrary form, and may be a screen provided in the virtual space, a large screen display provided in the virtual space, a display of a mobile terminal in the virtual space, or the like.

In addition, the content in virtual reality may be perceptible by methods other than the method using a head-mounted display as described above. For example, the content in virtual reality may be viewed directly (not through a head-mounted display) through a smartphone, a tablet, or the like.

(Configuration of a Server Apparatus)

The configuration of the server apparatus will be described concretely. The server apparatus 10 may be a server computer. The server apparatus 10 may be realized by cooperation between a plurality of server computers. For example, the server apparatus 10 may be realized by cooperation between a server computer that provides various contents, a server computer that realizes various authentication servers, and the like. In addition, the server apparatus 10 may include a web server. In this case, some of the functions of the terminal apparatus 20, which will be described later, may be realized by the browser processing the HTML document received from the web server or various programs (Javascript) attached thereto.

The server apparatus 10 includes a server communication unit 11, a server storage unit 12, and a server control unit 13, as shown in FIG. 1.

The server communication unit 11 may include an interface that performs wireless or wired communication with an external apparatus to transmit and receive information. The server communication unit 11 may include, for example, a wireless local area network (LAN) communication module or a wired LAN communication module. The server communication unit 11 can transmit and receive information to and from the terminal apparatus 20 through the network 3.

The server storage unit 12 is, for example, a storage device, and stores various information and programs necessary for various processes related to virtual reality.

The server control unit 13 may include a dedicated microprocessor, a central processing unit (CPU) that may implement a specific function by reading a specific program, a graphics processing unit (GPU), or the like. For example, the server control unit 13 may cooperate with the terminal apparatus 20 to execute a virtual reality application according to the user's operation on a display unit 23 of the terminal apparatus 20.

(Configuration of a Terminal Apparatus)

The configuration of the terminal apparatus 20 will be described. As shown in FIG. 1, the terminal apparatus 20 may include a terminal communication unit 21, a terminal storage unit 22, a display unit 23, an input unit 24, and a terminal control unit 25.

The terminal communication unit 21 may include an interface that performs wireless or wired communication with an external apparatus to transmit and receive information. The terminal communication unit 21 may include a wireless communication module, a wireless LAN communication module, a wired LAN communication module, and the like that support mobile communication standards, such as LTE (Long Term Evolution), LTE-A (LTE-Advanced), fifth-generation mobile communication systems, and UMB (Ultra Mobile Broadband). The terminal communication unit 21 can transmit and receive information to and from the server apparatus 10 through the network 3.

The terminal storage unit 22 may include, for example, a primary storage device and a secondary storage device. For example, the terminal storage unit 22 may include a semiconductor memory, a magnetic memory, or an optical memory. The terminal storage unit 22 may store various kinds of information and programs received from the server apparatus 10 and used for virtual reality processing. Information and programs used for virtual reality processing may be acquired from an external apparatus through the terminal communication unit 21. For example, a virtual reality application program may be acquired from a predetermined application distribution server. Hereinafter, the application program will also simply be referred to as an application.

In addition, the terminal storage unit 22 may store data for drawing a virtual space, for example, an image of an indoor space such as a building or an outdoor space. In addition, a plurality of types of data for drawing the virtual space may be prepared for each virtual space and used separately.

In addition, the terminal storage unit 22 may store various images (texture images) for projection (texture mapping) onto various objects arranged in the three-dimensional virtual space.

For example, the terminal storage unit 22 may store avatar drawing information regarding the participating avatar M1 as a virtual reality medium associated with each user. The participating avatar M1 may be drawn in the virtual space based on avatar drawing information regarding the participating avatar M1.

In addition, the terminal storage unit 22 may store avatar drawing information regarding the moderator avatar M2 as a virtual reality medium associated with each host side user. The moderator avatar M2 may be drawn in the virtual space based on avatar drawing information regarding the moderator avatar M2.

In addition, the terminal storage unit 22 may store drawing information regarding various objects different from the participating avatar M1 or the moderator avatar M2, such as various gift objects, buildings, walls, and non player characters (NPCs). Various objects are drawn in the virtual space based on such drawing information. In addition, the gift object is an object corresponding to a gift from one user to another user, and is a part of an item. Gift objects may be things (clothes and accessories) worn by the avatar, things (fireworks, flowers, and the like) for decorating the talk room image (or the corresponding space in the virtual space), backgrounds (wallpaper) or the like, and a ticket or the like for a lottery. In addition, the term “gift” used in this application means the same concept as the term “token”. Therefore, it is also possible to replace the term “gift” with the term “token” to understand the technique described in this application.

The display unit 23 includes a display device, such as a liquid crystal display or an organic electro-luminescence (EL) display. The display unit 23 can display various images. The display unit 23 is, for example, a touch panel, and functions as an interface for detecting various user operations. In addition, the display unit 23 may be built in the head-mounted display as described above.

The input unit 24 may include physical keys, and may further include an arbitrary input interface including a pointing device such as a mouse. In addition, the input unit 24 may be capable of receiving non-contact user input such as voice input, gesture input, and line-of-sight input. In addition, for gesture input, sensors (image sensors, acceleration sensors, distance sensors, and the like) for detecting various states of the user, dedicated motion capture in which sensor technology and cameras are integrated, a controller such as a joypad, and the like may be used. In addition, the line-of-sight detection camera may be arranged in the head-mounted display. In addition, as described above, the various states of the user may be, for example, the user's direction, location, movement, and the like. In this case, the direction, location, and movement of the user are a concept including not only the direction, location, and movement of a part or entirety of the user's body, such as the face or hands, but also the direction, location, movement, and the like of the user's line of sight.

The terminal control unit 25 may include one or more processors. The terminal control unit 25 may control the operation of the terminal apparatus 20 as a whole.

The terminal control unit 25 may transmit and receive information through the terminal communication unit 21. For example, the terminal control unit 25 may receive various kinds of information and programs used for various processes related to virtual reality from at least one of the server apparatus 10 and other external servers. The terminal control unit 25 may store the received information and program in the terminal storage unit 22. For example, the terminal storage unit 22 may store a browser (Internet browser) for connecting to a web server.

The terminal control unit 25 may activate a virtual reality application according to the user's operation. The terminal control unit 25 may cooperate with the server apparatus 10 to perform various processes related to virtual reality. For example, the terminal control unit 25 may cause the display unit 23 to display an image of the virtual space. For example, a graphic user interface (GUI) for detecting a user operation may be displayed on the screen. The terminal control unit 25 can detect a user operation through the input unit 24. For example, the terminal control unit 25 can detect various operations (operations corresponding to a tap operation, a long tap operation, a flick operation, a swipe operation, and the like) by gestures of the user. The terminal control unit 25 may transmit the operation information to the server apparatus 10.

The terminal control unit 25 may draw the moderator avatar M2 or the participating avatar M1 together with the virtual space (image), and may the display unit 23 to display the terminal image. In this case, for example, as shown in FIG. 2, a stereoscopic image may be generated by generating images G200 and G201 visually recognized with the left and right eyes, respectively. FIG. 2 schematically shows the images G200 and G201 visually recognized by the left and right eyes, respectively. In the following description, unless otherwise specified, the virtual space image refers to the entire image expressed by the images G200 and G201. In addition, the terminal control unit 25 may realize various movements of the moderator avatar M2 in the virtual space, for example, according to various operations of the host side user. A specific drawing process of the terminal control unit 25 will be described later.

Incidentally, in the case of user participation type talk content such as specific talk content by the host side user, when many users, including beginner users, can participate, the excitement or activity level of the conversation increases and accordingly, the appeal of the talk content increases. In addition, there is also the effect of promoting interaction between users and increasing the appeal of the virtual space.

However, when a large number of user participation type talk contents are distributed, it may not be easy for each user to find talk contents in which participation is easy. For example, when the theme or the like of talk content cannot be understood from thumbnails alone, the hurdles to viewing or participating in the talk content tend to be high. In addition, there is also a problem that it is not possible to reach talk content where people interested in conversation gather due to the difference in language used. In addition, there is also a problem of not knowing what language or interests the other party has unless they have a conversation or utterance.

In addition, such a problem can occur not only in specific talk content by the host side user when the users are divided into the host side and the participant side but also in free-to-participate (free-to-enter) talk rooms when the users are not divided into the host side and the participant side. For example, in a virtual space where avatars can freely move around (world type virtual space), there can be a case where various talk rooms are set in the virtual space or a case where a plurality of avatars gather and a talk room occurs naturally. In addition, even in the world type virtual space, the specific talk content may be generated based on the terminal image from the viewpoint of the virtual camera arranged in the virtual space. Even in such a case, when the theme of the conversation being held in the talk room is unknown from the outside, the hurdles to entering the talk room tend to be high.

Therefore, in the present embodiment, as will be described in detail later, a talk theme (conversation theme) may be specified and output for specific talk content by the host side user, a conversation in a free-to-participate (free-to-enter) talk room, and the like, so that it is possible to lower the hurdles to viewing or participation of each user for the specific talk content, the conversation in a talk room, and the like. In other words, it is possible to encourage each user to view or participate in specific talk content, conversations in talk rooms, and the like. Therefore, since viewing or participation is activated, it is possible to effectively promote the participation of new users in the conversation, that is, start of a new conversation. In addition, in the present embodiment, it is possible to simultaneously achieve a reduction in the amount of data or processing load and activation of communication. For example, when the information processing system is designed to output all the details of a conversation before entering into the conversation, the amount of communication data will increase and the amount of information will be too large for the user to understand. On the other hand, in the present embodiment, as will be described in detail later, only the talk theme is displayed before entering into the conversation, and the details can be viewed only after participating in the conversation, so that it is possible to simultaneously achieve a reduction in processing load on servers or terminals and activation of communication by efficiently selecting a conversation in which the user desires to participate. In addition, in the present embodiment, it is possible to reduce the number of operations performed by the user, thereby improving usability and reducing the processing load. That is, in the present embodiment, as will be described in detail later, it is possible to reduce the number of operations until the user reaches a desired conversation by searching for the conversation by talk theme, or by displaying the talk theme before participating in the conversation, or by guiding the user to the conversation of his or her favorite talk theme. Therefore, it is possible to improve usability and reduce the processing load.

Here, a configuration related to the talk theme will be described with reference to FIGS. 3 to 15.

FIG. 3 is a conceptual diagram of one talk room in the virtual space. The example shown in FIG. 3 is a conference style talk room 300R, and a display medium 302R (an example of a predetermined display medium) displaying the talk theme is associated with the talk room 300R. The display medium 302R may include images, videos, 3D objects, and the like as well as text information indicating the corresponding talk theme. As will be described later, the talk theme may be specified by extracting a keyword in a conversation held in a talk room. Alternatively, an association table between the extracted keyword or text information of the talk theme and images, videos, 3D objects, and the like may be prepared, and the talk theme may be specified according to the image, video, 3D object, and the like corresponding to the talk theme. In the following description, the term “text information” is used as a concept including images, videos, 3D objects, and the like obtained in this manner. Having such a display medium 302R makes it possible to encourage each user to view or participate in the conversation in the talk room 300R. Although the display medium 302R is in the form of a signboard (second object M3) in FIG. 3, other forms may be applied.

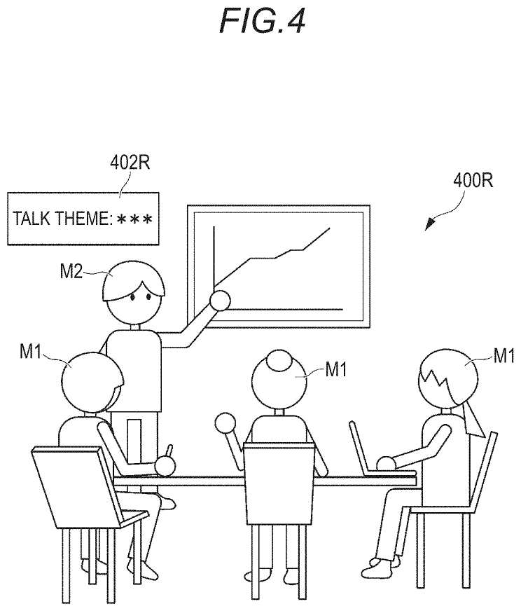

FIG. 4 is a conceptual diagram of another talk room in the virtual space. The example shown in FIG. 4 is a presentation style or panel discussion style talk room 400R, and a display medium 402R displaying the talk theme is associated with the talk room 400R. The display medium 402R may include text information indicating the corresponding talk theme. Having such a display medium 402R makes it possible to encourage each user to view or participate in the conversation in the talk room 400R. That is, by allowing users to grasp the content of the conversation before participating in the conversation that has already started, participation in the conversation can be promoted and communication between users can be made active.

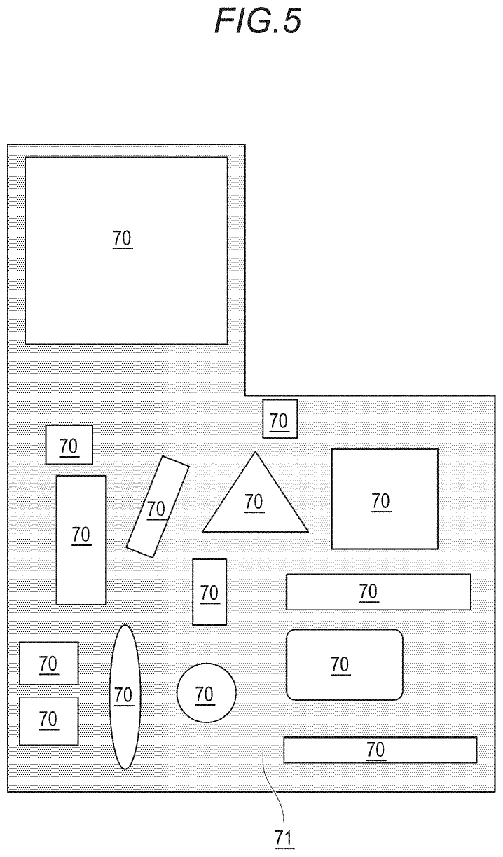

FIG. 5 is an explanatory diagram of an example of a virtual space that can be generated by the virtual reality generation system 1.

In the present embodiment, the virtual space may include a plurality of space portions. Each of the plurality of space portions is a space portion where the participating avatar M1 can enter, and each of the plurality of space portions may be capable of providing unique content. Each of the plurality of space portions may be generated in a mode of forming spaces that are continuous with each other in the virtual space, similarly to various spaces in the real world. Alternatively, some or all of the plurality of space portions may be partitioned by walls or doors (second object M3) interposed therebetween, or may be discontinuous with each other. A discontinuity is a relationship in which a connection is made in a manner that defies the laws of physics in reality, and is a relationship between space portions between which a movement can be made in a manner of teleportation, such as warping.

In the example shown in FIG. 5, the virtual space may include a plurality of space portions 70 for talk rooms and a free space portion 71. In the free space portion 71, the participating avatar M1 can basically move freely. In addition, also in the free space portion 71, a conversation related to specific talk content (for example, specific talk content, which will be described later, provided in the space portion 70) can be held as appropriate.

The space portion 70 may be a space portion at least partially separated from the free space portion 71 by a wall (an example of the second object M3) or a movement-prohibited portion (an example of the second object M3). For example, the space portion 70 may have a doorway (for example, the second object M3 such as a hole or a door) through which the participating avatar M1 can enter and exit the free space portion 71. The space portion 70 may function as a talk room in which the participating avatar M1 located in the space portion 70 can participate (that is, the space portion 70 may function as the space portion 70 in which a virtual camera for a terminal image related to the specific talk content is arranged). In addition, although each of the space portion 70 and the free space portion 71 is drawn as a two-dimensional plane in FIG. 5, each of the space portion 70 and the free space portion 71 may be set as a three-dimensional space. For example, each of the space portion 70 and the free space portion 71 may be a space having walls or a ceiling in a range corresponding to the planar shape shown in FIG. 5 as a floor. Alternatively, apart from the example shown in FIG. 5, each of the space portion 70 and the free space portion 71 may be a space with a height such as a dome or a sphere, a structure such as a building, a specific place on the earth, or a world that simulates outer space or the like where avatars can fly around.

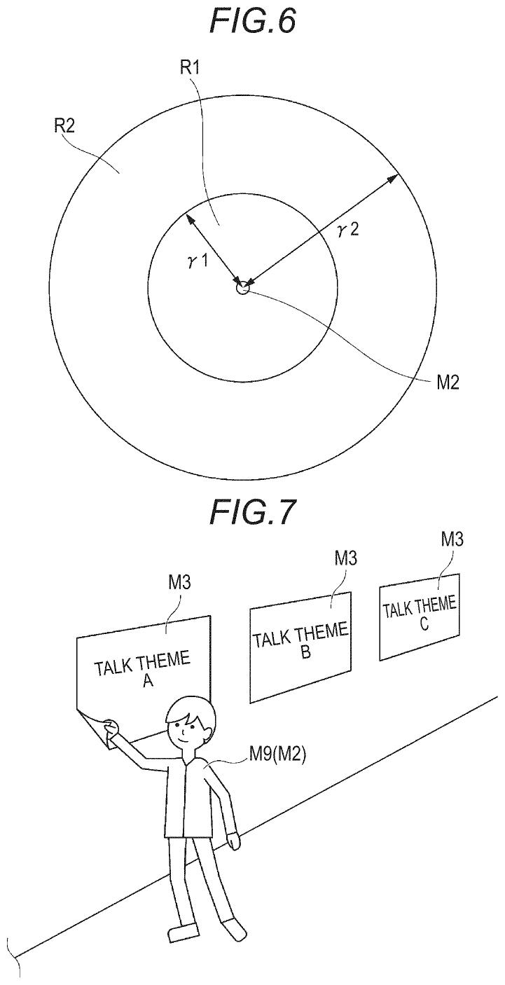

FIG. 6 is an explanatory diagram of regions with different attributes around the moderator avatar M2 in the virtual space. As will be described later, a region R1 with a first attribute and a region R2 with a second attribute may be provided in the virtual space. The region R1 may be a region where the user can view the details (conversation voice, chat text, and the like) of the conversation in the virtual space and can have his or her own conversation, while the region R2 is a region where the user can view the details of the conversation in the virtual space but cannot have his or her own conversation. (As previously noted, in various exemplary embodiments, it may be contemplated for the user to perceive this information via one or more of a variety of senses; for example, in an embodiment where conversation voice is provided, this may be heard by the user instead of being seen or in addition to being seen, and so forth.) Outside the region R2, the user can view the talk theme, and after entering the region R2, the user can view the details of the conversation. At this time, the display of the talk theme may disappear.

In the present embodiment, the region R1 with the first attribute and the region R2 with the second attribute different from the first attribute may be formed around the moderator avatar M2 in the virtual space. In addition, each of the region R1 with the first attribute and the region R2 with the second attribute may be a set of a plurality of locations. The region R1 with the first attribute and the region R2 with the second attribute may be defined in a manner included in the talk room. In other words, the talk room may be defined by the region R1 with the first attribute and the region R2 with the second attribute. However, the talk room may include a region outside the region R2 with the second attribute. In addition, in the modification example, regions with other attributes, for example, a region with a third attribute in which collaboration with the moderator avatar M2 is possible and a region with a fourth attribute in which only the moderator avatar M2 can be located may be defined. In addition, although each of the regions R1 and R2 is drawn in a circular shape as a two-dimensional plane in FIG. 6, the regions R1 and R2 may be set in a spherical shape in a three-dimensional space as in FIG. 5.

The region R1 with the first attribute may be a region where a conversation between the moderator avatar M2 and the participating avatar M1 and/or a conversation between a plurality of participating avatars M1 are possible, and may be set closer to the moderator avatar M2 than the region R2 with the second attribute. In the example shown in FIG. 6, the region R1 with the first attribute may correspond to a circular region with a radius r1 around the moderator avatar M2, but any form or size is possible. For example, the size of the region R1 with the first attribute (for example, the size of the radius r1) may be constant (fixed), or may be variable in such a manner that the size of the region R1 with the first attribute increases as the number of participating avatars M1 in the region R1 with the first attribute increases.

The region R2 with the second attribute is a region where only viewing the conversation between the moderator avatar M2 and the participating avatar M1 in the region R1 with the first attribute is allowed. That is, unlike the region R1 with the first attribute, the region R2 with the second attribute is a region where a conversation with the moderator avatar M2 is not allowed but a conversation between the moderator avatar M2 and the participating avatar M1 in the region R1 with the first attribute can be viewed. Due to such attributes, the region R2 with the second attribute may be set farther from the moderator avatar M2 than the region R1 with the first attribute. For example, the region R2 with the second attribute may be set adjacent to the region R1 with the first attribute. In the example shown in FIG. 6, the region R2 with the second attribute may correspond to a circular region having an inner radius r1 and an outer radius r2 that surrounds the region R1 with the first attribute, but any form or size is possible. For example, the size of the region R2 with the second attribute (for example, the size of the radius r2) may be constant (fixed), or may be variable in such a manner that the size of the region R2 with the second attribute increases as the number of participating avatars M1 in the region R2 with the second attribute (or the value of a specific parameter such as an activity level parameter, which will be described later) increases.

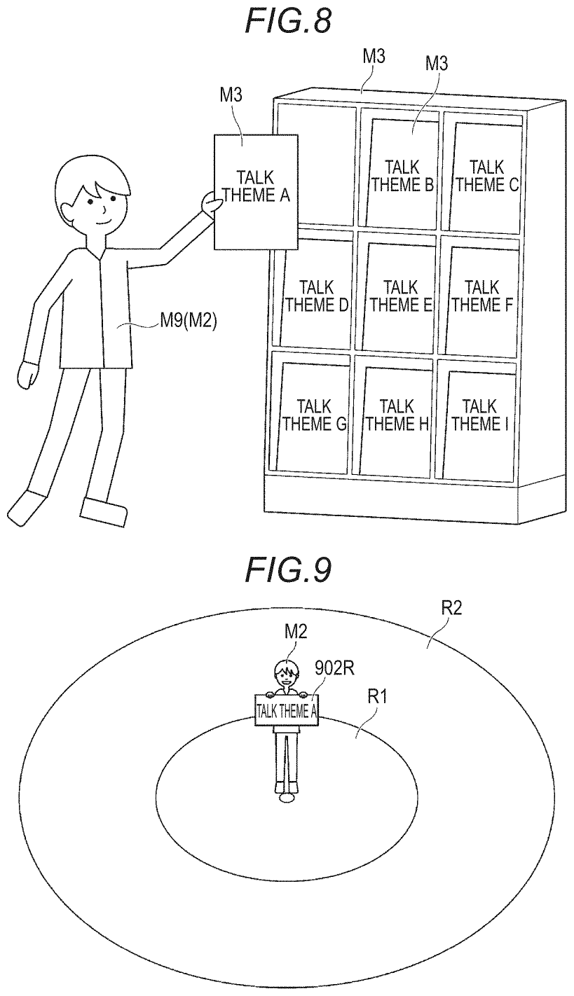

Incidentally, in the virtual space, the moderator avatar M2 may be determined in advance along with the talk room. For example, the user related to the moderator avatar M2 may reserve a region (for example, the space portion 70) related to the talk room in advance and hold a talk event or the like. Alternatively, the talk room may be newly generated in response to the generation instruction from the user related to the moderator avatar M2. Alternatively, the talk room may occur naturally (for example, haphazardly) in the free space portion 71, for example. For example, as shown in FIG. 7, a poster (second object M3) related to a talk theme may be pasted on a wall (second object M3) in advance, and an avatar M9 related to a user who desires to have a conversation with another user may hold the poster related to the corresponding desired talk theme, so that it is possible to form a talk room (and accordingly become the moderator avatar M2 related to the talk room). In addition, instead of the poster related to the talk theme, as shown in FIG. 8, the talk theme may be written on a pamphlet or booklet (second object M3) placed on a leaflet rack or bookshelf (second object M3). In this manner, by allowing the user to select the talk theme from posters, pamphlets, and the like and form a talk room, it is possible to lower the psychological hurdles to start a conversation. As a result, it is possible to obtain the effect that communication between users in the virtual space becomes more active. In addition, these talk themes may be edited or newly created by a specific user or an administrator. In this case, the avatar M9 of the user who desires to be the moderator avatar M2 may become the moderator avatar M2 by holding a pamphlet on the corresponding desired talk theme. When the moderator avatar M2 is created in this manner, the region R1 with the first attribute and the region R2 with the second attribute may be set around the moderator avatar M2 as shown in FIG. 9, or talk rooms such as those shown in FIGS. 3 to 5, 10 and 11, and the like may be generated by the user picking up a poster or pamphlet. In this case, the pamphlet (display medium 902R showing a talk theme) held by the moderator avatar M2 may function as a signboard that can be visually recognized from multiple directions. As a result, even from avatars located in arbitrary directions around the moderator avatar M2, the talk theme can be easily visually recognized. In addition, when the moderator avatar M2 moves in the virtual space, the region R1 with the first attribute and the region R2 with the second attribute may also move accordingly.

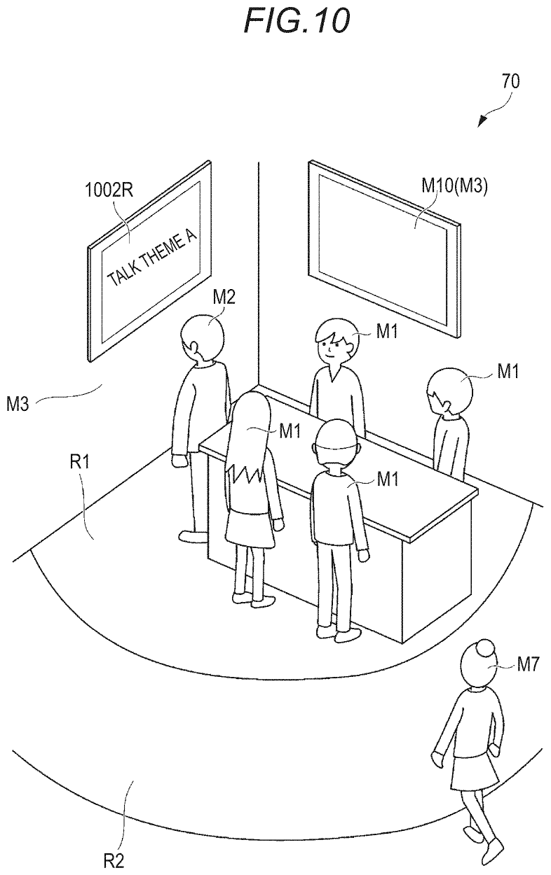

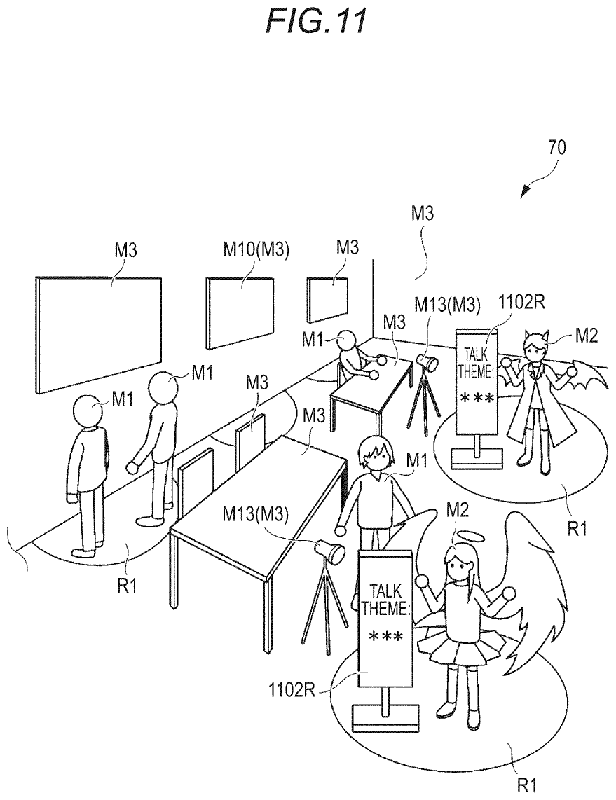

FIGS. 10 and 11 are explanatory diagrams of various forms of a talk room. For example, a talk room may be set in the space portion 70 in the form of a cafe as shown in FIG. 10, or a plurality of talk rooms may be set in the space portion 70 in the form of a relatively large event venue as shown in FIG. 11.

For example, in the example shown in FIG. 10, a display medium 1002R displaying a talk theme is associated with the wall (second object M3) in the space portion 70 related to the cafe. The display medium 1002R may include text information indicating the corresponding talk theme and the like. The display medium 1002R may be provided at a location that is easily visible from the viewpoint of another user, an avatar M7 who is about to enter the region R2 from outside the region R2. In this case, it is possible to encourage each user to view or participate in the conversation in the talk room.

In addition, in the example shown in FIG. 10, the space portion 70 may be in the form of a paid cafe that requires payment of a predetermined fee (for example, 500 yen per 30 minutes) in order to enter the region R1 with the first attribute. In this case, a display medium (second object M3) (not shown) displaying the charge system may be arranged on the wall (second object M3) in the space portion 70 related to the cafe. In this case, the user can continue to stay in the region R1 with the first attribute by paying an extension fee every 30 minutes, for example. A user who has not paid the extension fee may be automatically logged out (fade out), or may be expelled from the talk room. In this case, restrictions may occur. For example, the drawing (visibility for other users) of the participating avatar M1 may become faint for a user who has not paid the extension fee or the participating avatar M1 related to the user, or the voice from the moderator avatar M2 or the like in the talk room (audibility of the voice for other users) may become low, or the utterance from the moderator avatar M2 or the like in the talk room may not be converted into text information or the like. In addition, payment of charges in the virtual space may be realized by consumption of a predetermined medium (for example, consumption of purchasable points or consumption of specific virtual currency).

In addition, in the example shown in FIG. 11, a talk room for a plurality of moderator avatars M2 may be set in the event venue. In this case, a display medium 1102R displaying the corresponding talk theme is associated with each of the plurality of (two in FIG. 11) moderator avatars M2. Each display medium 1102R may include text information indicating the corresponding talk theme and the like. In addition, instead of or in addition to the display medium 1102R displaying the corresponding talk theme, the moderator avatar M2 may be in the form of a character that indicates or suggests (including association with) the talk theme. In this case, the moderator avatar M2 itself can function as a display medium showing that the corresponding character is the talk theme. Such a configuration may be suitable when the talk theme does not change. In this manner, by setting a plurality of talk rooms related to each character at the event venue, it is possible to activate conversations on the talk theme related to each character.

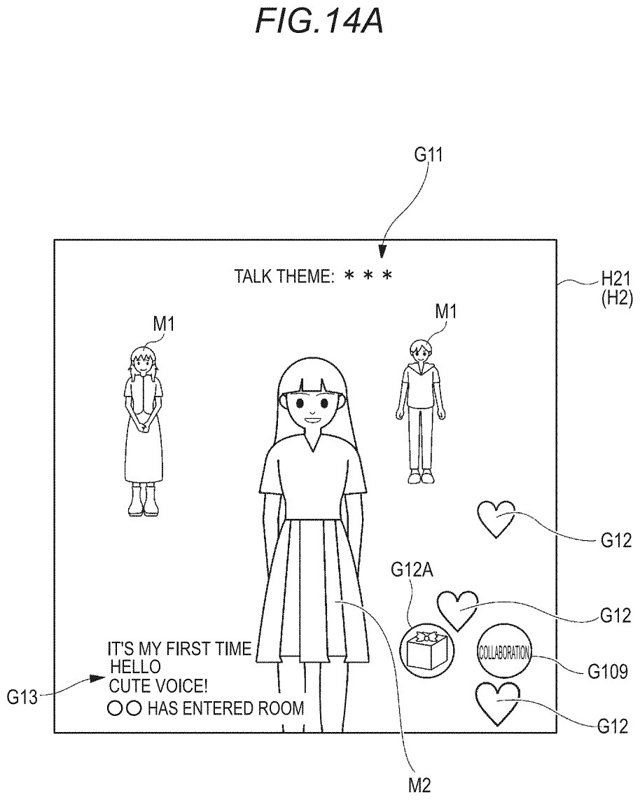

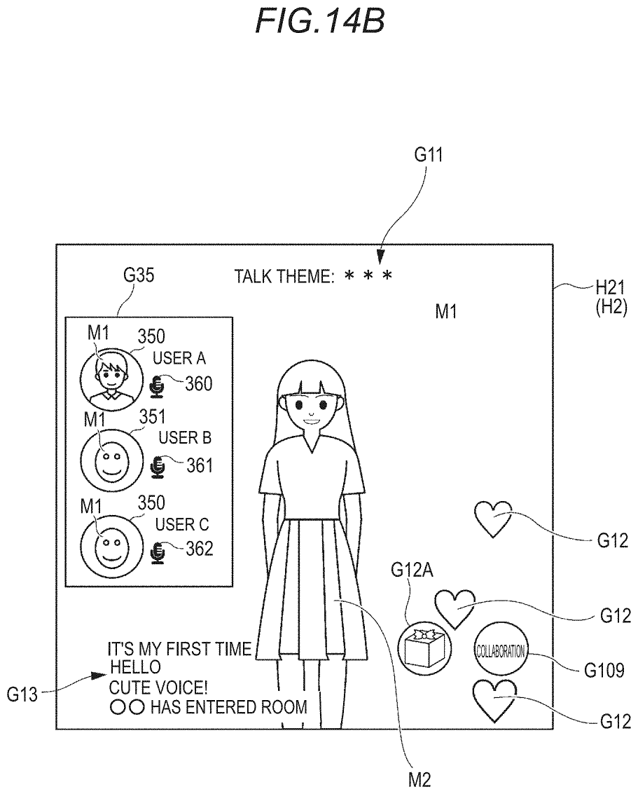

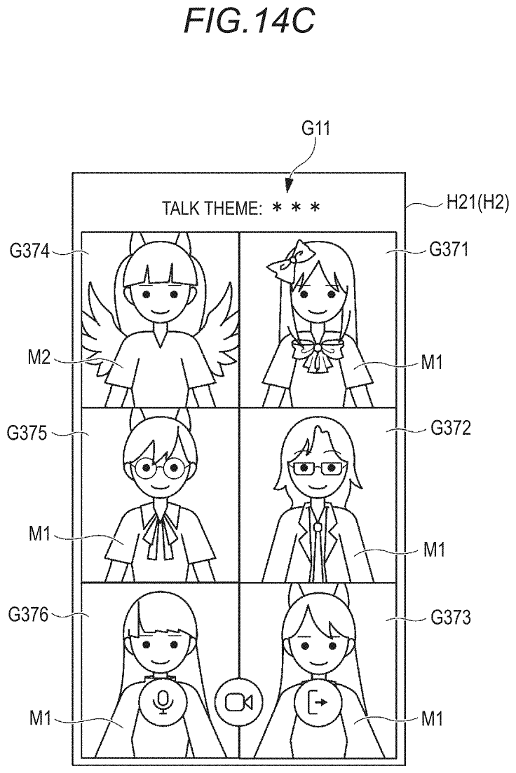

In addition, in the example shown in FIG. 11, each participating avatar M1 may be allowed to take a commemorative photo with the moderator avatar M2. In this case, a camera object M13 (second object M3) may be arranged in association with each moderator avatar M2. The image captured by the camera object M13 may be provided to the user so as to be perceptible by the user related to the corresponding participating avatar M1. In addition, the camera object M13 may function as a virtual camera. In this case, a video from the virtual camera may be used to generate a terminal image (see a talk room image H21 in FIG. 14A) for viewing on a smartphone or the like.

In addition, in the example shown in FIG. 11, a pamphlet (second object M3) or an original image (second object M3) related to the corresponding event, a display object M10 (second object M3) that allows viewing of the video of the interview, and the like may be arranged on the wall (second object M3) in the space portion 70. In this case, a talk room may occur naturally due to the second object M3. In addition, a chair or a desk (second object M3) on which an avatar can sit may be arranged in the space portion 70, and music of a sound source related to the corresponding event may be played. Such a chair or desk may appear when a talk room is generated. In addition, in the case of the moderator avatar M2 and the participating avatar M1 in each region R1 shown in FIG. 11, a conversation between the moderator avatar M2 and the participating avatar M1 and/or a conversation between the participating avatars M1 may be possible in each region R1.

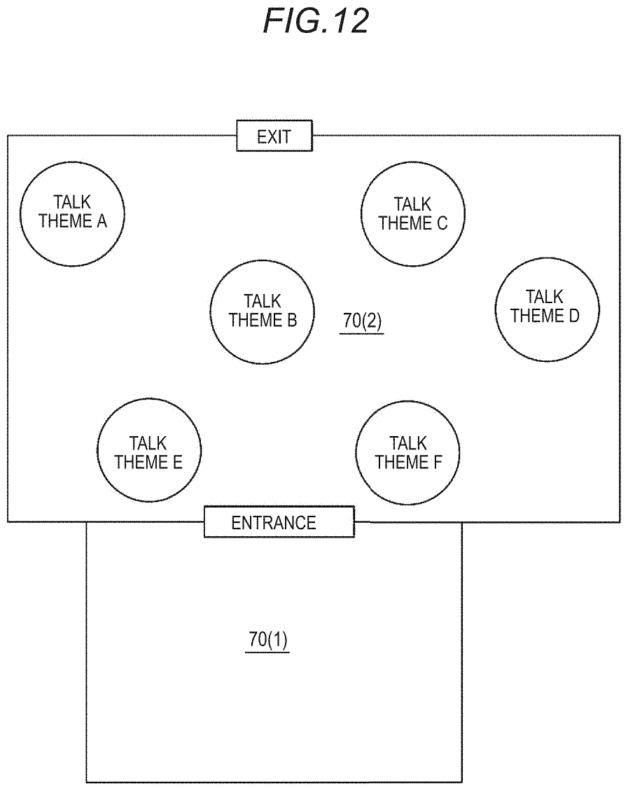

FIG. 12 is an explanatory diagram of an arrangement example of talk rooms according to the details (hierarchy) of the talk theme. FIG. 12 shows various talk rooms in the space portion 70 (in FIG. 12, reference numeral 70(2)) in the form of a lobby adjacent to the space portion 70 (in FIG. 12, reference numeral 70(1)) in the form of an event venue, such as a movie theater. In FIG. 12, talk themes A to F may be associated with the various talk rooms. Each of the talk themes A to F may be associated with the event at the event venue, and may be set in such a manner that the content gradually becomes more detailed from the entrance to the event venue (exit from the event venue to the lobby) toward the exit of the lobby. For example, in the example shown in FIG. 12, the talk themes E and F may be more for beginners than the talk themes A and C. In this case, users who have experienced the event at the event venue can gradually deepen their knowledge of the event by visiting the talk rooms in order until they head to the exit of the lobby after leaving the event venue to the lobby. In FIG. 12, the space portion 70 in the form of a lobby is adjacent to the space portion 70 in the form of an event venue, such as a movie theater, but the disclosure is not limited thereto. For example, an avatar coming out of the space portion 70 may be guided to a talk room (space portion 70 that is not adjacent to the space portion 70 in the form of an event venue such as a movie theater) where conversations are being held on related talk themes.

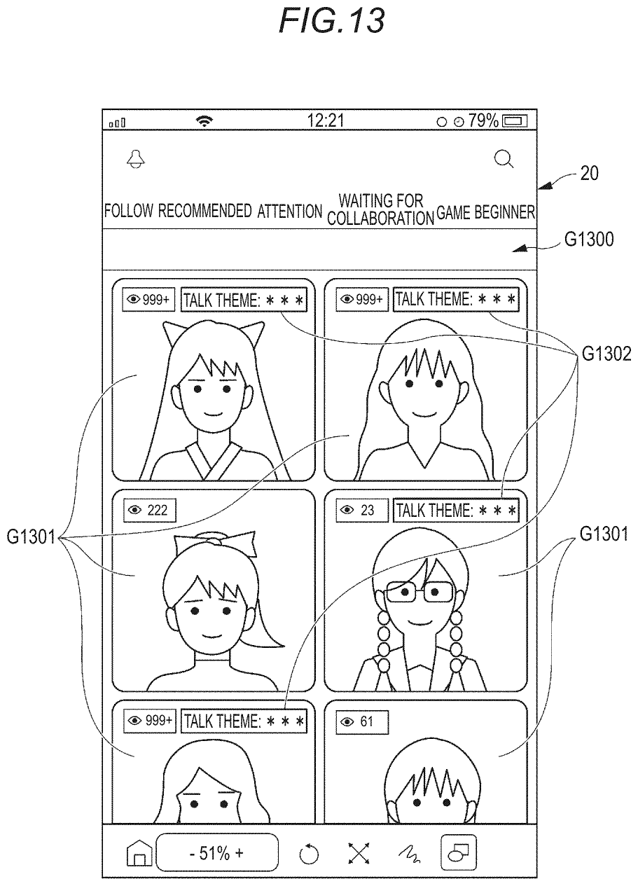

FIG. 13 is an explanatory diagram showing an example of a talk room selection screen for viewing on a smartphone (an example of the terminal apparatus 20) or the like.

In the example shown in FIG. 13, a talk room selection screen G1300 for viewing may display list information including selection items corresponding to various talk rooms (distribution items of specific talk content being distributed or scheduled to be distributed).

Selection items G1301 corresponding to various talk rooms preferably include thumbnails and theme displays G1302 (theme information) showing the corresponding talk themes. The theme display G1302 may include text information indicating the talk theme and the like. In this case, it is possible to encourage each user to view or participate in the conversation in the talk room. In addition, the number of selection items G1301 included in one screen may be appropriately set according to the screen size, and the talk room selection screen G1300 can be scrolled to change the displayed selection items G1301.

FIG. 14A is a diagram showing an example of a talk room image H2 (terminal image) for a participant side user when the participant side user enters one talk room through the talk room selection screen shown in FIG. 13. The talk room image H2 may be generated based on a virtual camera in the virtual space, may be generated by the studio units 30A and 30B, or may be generated based on an image captured by the camera of the terminal apparatus 20. FIGS. 14B and 14C are diagrams showing other examples of the talk room image H2 for a participant side user.

In addition, the talk room image H2 may include not only the talk room image H21 that can be visually recognized without going through the head-mounted display (hereinafter, also referred to as “talk room image H21 for smartphones” or simply “talk room image H21”) (see FIG. 14A) but also a talk room image that can be visually recognized through the head-mounted display, which is a talk room image for a host side user or a talk room image for a participant side user.

When a participant side user enters one talk room through a talk room selection screen G1300, the participant side user can select either entering the talk room in a manner in which a conversation is possible (for example, entering the region R1 with the first attribute) or entering the talk room in a manner in which viewing only is possible (for example, entering the region R2 with the second attribute). Alternatively, entering the talk room through the talk room selection screen G1300 may be set in advance as either entering the talk room in a manner in which a conversation is possible (for example, entering the region R1 with the first attribute) or entering the talk room in a manner in which viewing only is possible (for example, entering the region R2 with the second attribute).

As shown in FIGS. 14A, 14B, and 14C, the talk room image H21 may include a theme display G11 (theme information) showing the corresponding talk theme. The theme display G11 may include text information indicating the talk theme and the like. Therefore, the participant side user can check the talk theme even after entering the room. In addition, such a theme display G11 is suitable when the talk theme related to one talk room can change dynamically.

In addition, in the example shown in FIG. 14A, in addition to the theme display G11 showing the talk theme, a heart-shaped gift object G12, a present-shaped gift object G12A, various comments G13 such as “it's my first time, . . . ”, an operation portion G109 for transmitting a request for collaboration distribution to other host side users, and the like are drawn together with the moderator avatar M2.

Incidentally, in the terminal apparatus 20 with a relatively small screen such as a smartphone, the participating avatar M1 may be expressed in a panel format as shown in FIG. 14B. Specifically, the participating avatar M1 may be drawn as an avatar icon in an image region G35. In this case, each of avatar icons 350, 351, and 352 indicates a virtual space to which the corresponding avatar belongs. In this case, corresponding user names (for example, “user A”, “user B”, and “user C”) may be associated with the avatar icons 350, 351, and 352. In addition, microphone icons 360, 361, and 362 may be associated with the avatar icons 350, 351, and 352, respectively. In this case, among the microphone icons 360, 361, and 362, the microphone icon corresponding to the speaking participating avatar M1 may be emphasized (for example, enlarged in size, blinked, or colored) in a similar manner. In this case, the size of the microphone icon may be changed according to the loudness (volume) of the voice.

Alternatively, as shown in FIG. 14C, the participating avatar M1 may be drawn in the form of avatar panels G371 to G376 together with the moderator avatar M2. Also in this case, each of the avatar panels G371 to G376 indicates a virtual space to which the corresponding avatar belongs. In this case, the virtual space may be expressed by a substantially two-dimensional display. In this case, among the avatar panels G371 to G376, the avatar panel corresponding to the speaking avatar may be emphasized (for example, enlarged in size, blinked, or colored) in a similar manner.

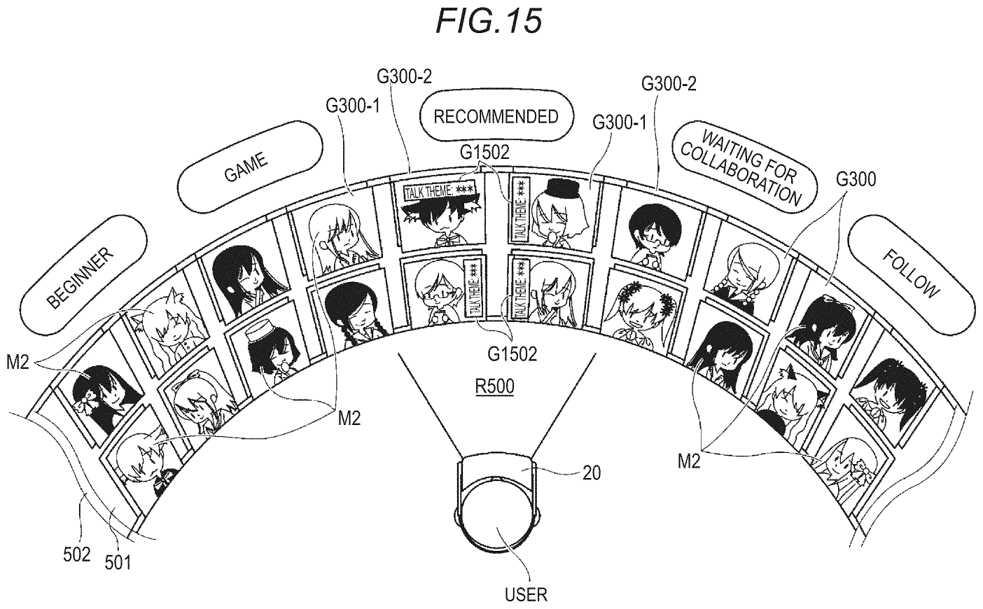

FIG. 15 is an explanatory diagram illustrating an example of a talk room selection screen for viewing on the head-mounted display.

In FIG. 15, a viewing range R500 from the user's point of view (when viewed from the front) is schematically shown in a top view, and a plurality of planar operation portions G300 visible through a head-mounted display (an example of the terminal apparatus 20) are shown. In this case, the screen that the user can visually recognize through the head-mounted display is a talk room selection screen for viewing when using the head-mounted display.

A plurality of planar operation portions G300 may function as selection items (distribution items of specific talk content being distributed or scheduled to be distributed) corresponding to various talk rooms. Therefore, the user can visually recognize list information including a plurality of selection items (operation portions G300) through the head-mounted display. Then, the user can select a desired selection item from the plurality of selection items (operation portions G300) by gesture input (for example, movement to reach a desired selection item) or the like.

Each of the plurality of planar operation portions G300 may include a thumbnail (for example, a thumbnail including the image of the moderator avatar M2) and a theme display G1502 (theme information) showing the corresponding talk theme. The theme display G1502 may include text information indicating the talk theme and the like. In this case, it is possible to encourage each user to view or participate in the conversation in the talk room.

The plurality of planar operation portions G300 may be arranged in a manner forming a plurality of layers back and forth. For example, the plurality of planar operation portions G300 may include a first group arranged in a plurality of columns along a first curved surface 501 around a predetermined reference axis and a second group arranged in a plurality of columns along a second curved surface 502 around the same predetermined reference axis. In this case, the second curved surface 502 may be offset behind the first curved surface 501 as shown in FIG. 15. In this case, when viewed from the user's point of view, a plurality of operation portions G300 of the first group (hereinafter, also referred to as “operation portions G300-1” in order to be distinguished from the second group) arranged along the first curved surface 501 overlap behind a plurality of operation portions G300 of the second group (hereinafter, also referred to as “operation portions G300-2” in order to be distinguished from the first group) arranged along the second curved surface 502. At this time, when viewed from the user's point of view, the operation portions G300-2 of the second group may be partially visible behind the operation portions G300-1 of the first group. In this case, it is possible to make the user aware of the presence of the operation portions on the back side and to efficiently increase the number of operation portions that can be noticed by the user. In addition, a third curved surface offset further behind the second curved surface may be set, and a further planar operation portion G300 may be arranged. In this manner, an arbitrary number (two or more) of planar operation portions G300 may be arranged in an overlapping manner when viewed from the user's point of view.

In addition, in the case of such a plurality of planar operation portions G300 overlapping each other back and forth, it is possible to efficiently reduce the processing load related to drawing while arranging a large number of operation portions G300 so as to be able to be operated by the user. For example, by performing incomplete drawing (for example, processing such as texture change) for the operation portion G300-2 while performing complete drawing of a thumbnail image or a real-time video only for the operation portion G300-1, it is also possible to reduce the processing load related to drawing as a whole. In addition, from the similar point of view, by performing incomplete drawing (for example, processing such as texture change) for the operation portion G300-1 outside the front region R500 while performing complete drawing of a thumbnail image or a real-time video only for the operation portion G300-1 in the front region R500 when viewed from the user's point of view among the operation portions G300-1, it is also possible to reduce the processing load related to drawing as a whole. For example, by pre-caching or pre-loading data, which is likely to be the operation portion G300-1 in the front region R500, in the terminal apparatus 20 of the user, it is possible to effectively reduce the number of requests submitted through the network 3, the amount of requests imposed on the network 3, and computing resources used to respond to the requests while reducing latency. In this case, the data that is likely to be the operation portion G300-1 in the front region R500 may be predicted based on the tendency of each user, or may be determined by machine learning based on artificial intelligence or the like.

When the plurality of operation portions G300-2 of the second group arranged along the second curved surface 502 overlap behind the plurality of operation portions G300-1 of the first group arranged along the first curved surface 501 when viewed from the user's point of view, the user may switch between the first group and the second group with a predetermined input of moving the hand in a predetermined manner. As a result, it is possible to improve operability through intuitive operation while efficiently arranging a large number of operation portions G300. In addition, in such a configuration in which a plurality of planar operation portions G300 are arranged, the user may change the arrangement of the plurality of planar operation portions G300 by a specific operation. Therefore, it is possible to arrange the operation portions G300 according to the user's preferences or tastes.

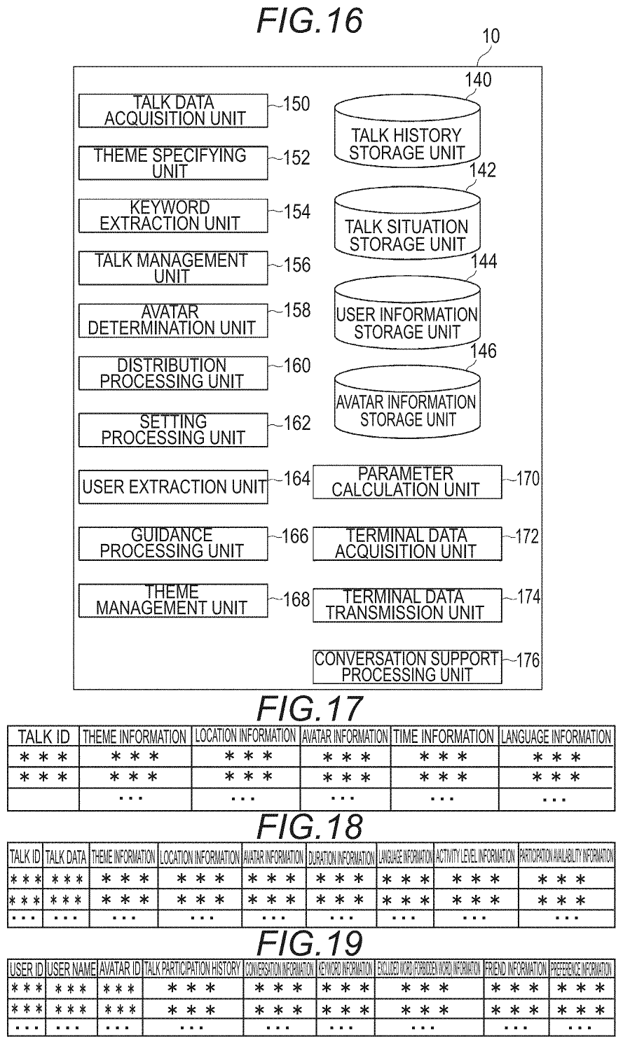

Next, functional configuration examples of the server apparatus 10 and the terminal apparatus 20 related to the above-described talk theme will be described with reference to FIG. 16 and subsequent diagrams.

First, functions of the server apparatus 10 will be mainly described with reference to FIGS. 16 to 22.

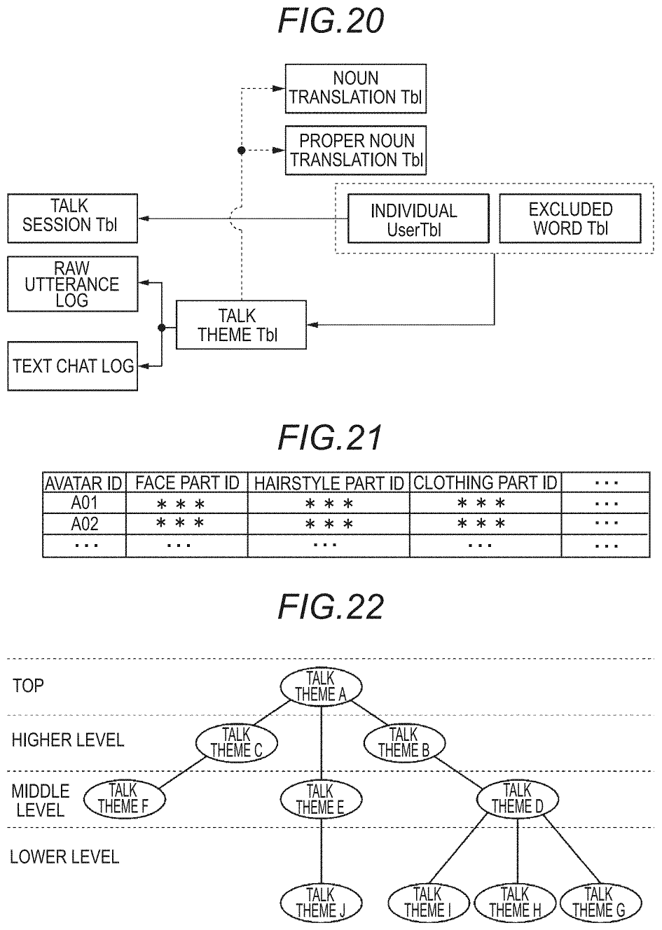

FIG. 16 is a schematic block diagram showing functions of the server apparatus 10 related to the talk theme described above. FIG. 17 is an explanatory diagram showing an example of data in a talk history storage unit 140. FIG. 18 is an explanatory diagram showing an example of data in a talk situation storage unit 142. FIG. 19 is an explanatory diagram showing an example of data in a user information storage unit 144. FIG. 20 is an explanatory diagram of various tables. FIG. 21 is an explanatory diagram showing an example of data in an avatar information storage unit 146. FIG. 22 is an explanatory diagram of the hierarchical structure of talk themes. In addition, in FIG. 17 (the same applies to FIG. 18 and the like below), “***” indicates a state in which some pieces of information may be stored, and “ . . . ” indicates a repetition state of the storage of similar information.

As shown in FIG. 16, the server apparatus 10 may include the talk history storage unit 140, the talk situation storage unit 142, the user information storage unit 144, the avatar information storage unit 146, a talk data acquisition unit 150, a theme specifying unit 152, a keyword extraction unit 154, a talk management unit 156, an avatar determination unit 158, a distribution processing unit 160, a setting processing unit 162, a user extraction unit 164, a guidance processing unit 166, a theme management unit 168, a parameter calculation unit 170, a terminal data acquisition unit 172, a terminal data transmission unit 174, and a conversation support processing unit 176.

In addition, in FIG. 16, the talk history storage unit 140, the talk situation storage unit 142, the user information storage unit 144, and the avatar information storage unit 146 can be realized by the server storage unit 12 of the server apparatus 10 shown in FIG. 1. In addition, the function of each unit from the talk data acquisition unit 150 to the conversation support processing unit 176 can be realized by the server control unit 13 or the server communication unit 11 of the server apparatus 10 shown in FIG. 1. Each of the above units may be implemented by, for example, a circuit element of the server apparatus 10; for example, a talk history storage unit 140 may be implemented in a memory element of the server apparatus 10.

The talk history storage unit 140 may store history information of each talk room formed in the virtual reality generation system 1. In the example shown in FIG. 17, in the talk history storage unit 140, items of theme information, location information, avatar information, time information, and language information are associated with each talk ID.

A talk ID may be assigned to each talk room. The form of a talk room to which a talk ID is assigned is arbitrary, and talk rooms to which talk IDs are assigned may include a talk room formed in the free space portion 71 in addition to the talk room formed in the space portion 70. In addition, talk rooms to which talk IDs are assigned may include a talk room for viewing on a smartphone or the like (see FIG. 14A) in addition to the talk room formed in the space portion 70 or the like.

The theme information may correspond to the talk theme related to the conversation in the corresponding talk room, and may indicate the talk theme specified by the theme specifying unit 152, which will be described later. In addition, when the talk theme changes in one talk room, a plurality of pieces of theme information may be associated with one talk ID. Alternatively, in a modification example, a new talk ID may be issued each time the talk theme changes.

The location information may indicate the location of the corresponding talk room (location in the virtual space). For example, when a talk room is formed in the space portion 70, the location information of the talk room may be the location information (coordinate values) of the space portion 70, or may be information specifying one corresponding space portion 70. In addition, when the talk room is movable (for example, when the talk room changes according to the location of the moderator avatar M2), the location information may include movement history.

In addition, for a talk room having the region R1 with the first attribute and the region R2 with the second attribute as described above, the location information may include information indicating the respective ranges of the region R1 with the first attribute and the region R2 with the second attribute.

The avatar information may be information (for example, a corresponding user ID or avatar ID) indicating the moderator avatar M2 in the corresponding talk room or each participating avatar M1 who has entered the corresponding talk room. The avatar information corresponding to one avatar may include detailed information such as the room entry time of the avatar. In addition, the avatar information may include the total number of participating avatars M1, the frequency of conversation, the number of utterances, and the like. In addition, the avatar information may include a participation attribute of each participating avatar M1 (attribute as to whether each participating avatar M1 is located in the region R1 with the first attribute or located in the region R2 with the second attribute). In addition, the avatar information may include attribute information indicating attributes of each avatar. For example, attribute information may be generated based on information registered in the account or profile (gender, preferences, and the like), first-person calling or wording based on voice analysis, presence or absence of dialect, action history (action history in the virtual space), purchased items (purchased items in the virtual space), and the like.

The time information may indicate the start time and end time of the corresponding talk room. In addition, the time information may be omitted for a talk room that is always formed.

The language information may indicate the language of the conversation held in the corresponding talk room. In addition, when the conversation is held in two or more languages, the language information may include two or more languages. In addition, a locale ID may be used as the language information.

The talk situation storage unit 142 may store information indicating the situation (current situation) in the currently formed talk room. In the example shown in FIG. 18, in the talk situation storage unit 142, items of talk data, theme information, location information, avatar information, duration information, language information, activity level information, and participation availability information are associated with each talk ID.

The talk data is data regarding the full content of the conversation being currently held in the corresponding talk room. The talk data may be raw data before processing (that is, a raw utterance log), or may be text data (converted into text).

The theme information may indicate a talk theme related to the conversation in the corresponding talk room. However, the theme information in the talk situation storage unit 142 may indicate a talk theme at the present moment.

The location information may indicate the location of the corresponding talk room. However, the location information in the talk situation storage unit 142 may indicate a location at the present moment. In addition, in the case of a specification in which the location of the talk room does not change, the location information in the talk situation storage unit 142 may be omitted. In addition, for a talk room having the region R1 with the first attribute and the region R2 with the second attribute as described above, the location information may include information indicating the respective ranges (ranges at the present moment) of the region R1 with the first attribute and the region R2 with the second attribute.

The avatar information is information (for example, a corresponding user ID or avatar ID) indicating the moderator avatar M2 in the corresponding talk room or each participating avatar M1 who has entered the corresponding talk room. However, the avatar information in the talk situation storage unit 142 may indicate each avatar located in the talk room at the present moment.

The duration information may indicate the duration of the corresponding talk room (elapsed time from the start time). In addition, for a talk room in which the talk theme has changed, the duration may be calculated for each talk theme.

The language information may indicate the language of the conversation being held in the corresponding talk room. In addition, when the conversation is held in two or more languages, the language information may include two or more languages.

The activity level information may indicate the activity level of the conversation held in the corresponding talk room. The activity level may be the current value of the activity level parameter calculated by the parameter calculation unit 170, which will be described later.

The participation availability information is information indicating whether an arbitrary user can participate in the corresponding talk room (enter the corresponding talk room). In addition, the participation availability information may include information such as conditions for participation (for example, conditions such as OK when accompanied by a friend or conditions related to limitations on the number of persons) in addition to participation availability. In addition, the participation availability information may include information such as an entrance fee.

The user information storage unit 144 may store information regarding each user. The information regarding each user may be generated, for example, at the time of user registration, and then updated as appropriate. For example, in the example shown in FIG. 19, in the user information storage unit 144, items of user name, avatar ID, talk participation history, conversation information, keyword information, excluded word (forbidden word) information, friend information, and preference information are associated with each user ID.

The user ID is an ID that is automatically generated at the time of user registration.

The user name is a name registered by each user himself or herself, and is arbitrary.

The avatar ID is an ID indicating the avatar used by the user. Avatar drawing information (see FIG. 21) for drawing the corresponding avatar may be associated with the avatar ID. In addition, avatar drawing information associated with one avatar ID may be added or edited based on an input from the corresponding user or the like.

The talk participation history may indicate information (for example, talk theme) regarding a talk room that the corresponding user has entered, and may be generated based on the data in the talk history storage unit 140 shown in FIG. 17. In addition, the talk theme may be used as a conversation tag. In this case, in the talk participation hi story, conversation tags of conversations in which the corresponding user has participated in the past may be displayed in the profile of the corresponding user. Among the conversations in which the user has participated in the past, a predetermined number of higher-rank conversation tags for which the user has a high number of participations may be displayed in the profile. In this case, even if all conversation tags cannot be displayed due to the limited space of the display unit 23 of the terminal apparatus 20 or even if the terminal apparatus 20 (for example, a mobile terminal such as a smartphone) has a small display unit 23, it is possible to effectively display the user's profile or necessary information for the user so as to be recognized by the user. For conversations in which the user has participated in the past, conversations in talk rooms in the past may be searched for by using conversation tags as keys. By searching for users with conversation tags, it is possible to find users with similar interests. Then, it is possible to find a user with whom it is desired to make friends by using a conversation tag and contact the user directly through a chat or the like, or it is possible to be told the location of the user in the virtual space (for example, “I am in the BB cafeteria”) or to warp to the location.

The conversation information may be information regarding the utterance content when the corresponding user speaks in the talk room that the user has entered. The conversation information may be text data. In addition, the conversation information may include information indicating which language is spoken (for example, a locale ID) or information regarding the total distribution time. In addition, the conversation information may include information regarding first-person calling, wording, dialect, and the like.

The keyword information may be information indicating a keyword in the conversation held in the talk room that the corresponding user has entered. The keyword information may indicate the user's preferences or the like with high accuracy, and may be used in the processing of the guidance processing unit 166, which will be described later.

The excluded word (forbidden word) information may relate to the number of times each user has uttered an excluded word (forbidden word). Excluded words (forbidden words) may be determined by the administrator, or may be added by the moderator avatar M2 in the corresponding talk room. In addition, information indicating that the user has never uttered an excluded word (forbidden word) may be associated with a user who has never uttered the excluded word (forbidden word).

The friend information may be information (for example, a user ID) by which a user in a friend relationship can be identified. The friend information may include information indicating interaction between users or the presence or degree of friendships.

The preference information may indicate preferences related to the talk theme, which are preferences of the corresponding user. The preference information is arbitrary, and may include the user's preferred language settings or preferred keywords. In addition, the user may set in advance a talk theme that the user likes or a talk theme that the user dislikes (a talk theme in which the user does not want to participate). In this case, the preference information may include such setting content. In addition, the preference information may also include user profile information. The preference information may be selected through a user interface generated on the terminal apparatus 20 and provided to the server apparatus 10 as a JSON (Javascript Object Notation) request or the like.

In addition, the preference information may be automatically extracted based on conversation information, action history, or the like. For example, the preference information may indicate the characteristics of a talk room that the user frequently enters. For example, even if the talk theme is the same, some users tend to prefer a large-scale talk room with a relatively large number of participants, while others tend to prefer a small-scale talk room with a relatively small number of participants. That is, preferences for the size of the talk room may be different. In addition, even if the talk theme is the same, some users tend to prefer a talk room with a high activity level (for example, a talk room in which the number of statements or the frequency of statements of each user is large and the conversation progresses actively (for example, abbreviated to “active talk room”)), while others tend to prefer a talk room with a low activity level (for example, a talk room in which the number of statements or the frequency of statements of each user is small and the conversation progresses quietly and relaxedly (for example, abbreviated to “relaxed talk room”)). That is, preferences for the size of the talk room may be different. Therefore, the preference information may include information indicating such preference trends.

Avatar drawing information for drawing each user's avatar may be stored in the avatar information storage unit 146. In the example shown in FIG. 21, in the avatar drawing information, a face part ID, a hairstyle part ID, a clothing part ID, and the like are associated with each avatar ID. Appearance-related parts information, such as a face part ID, a hairstyle part ID, a clothing part ID, is a parameter that characterizes the avatar, and may be selected by each user. For example, a plurality of types of appearance-related information, such as a face part ID, a hairstyle part ID, and a clothing part ID related to the avatar, are prepared. In addition, as for the face part ID, part IDs may be prepared for each type of face shape, eyes, mouth, nose, and the like, and information regarding the face part ID may be managed by combining the IDs of the parts that make up the face. In this case, it is possible to draw each avatar not only on the server apparatus 10 side but also on the terminal apparatus 20 side based on each appearance-related ID linked to each avatar ID.

Based on the log (utterance log) of the talk (utterance related to conversation) that occurs in the corresponding talk room, the talk data acquisition unit 150 updates talk data in the talk situation storage unit 142 for each currently formed talk room. That is, when a conversation-related input is acquired from the user regarding one talk room, the talk data acquisition unit 150 may include the information of the conversation-related input in the talk data in the talk situation storage unit 142. In addition, the update cycle of the talk data by the talk data acquisition unit 150 is arbitrary, and may be set to a relatively short cycle for a talk room whose talk theme is likely to change (a talk room with no defined talk theme, a talk room that occurs naturally as described above, and the like). As a result, changes in the talk room can be detected relatively quickly while reducing the load related to data update processing.

The theme specifying unit 152 may specify a talk theme in the corresponding talk room for each currently formed talk room. That is, the theme specifying unit 152 may specify the theme of the conversation established in the corresponding talk room, as a talk theme, for each currently formed talk room. The display mode of the talk theme is not particularly limited. As an example, a plurality of talk themes may be displayed. For example, the main theme may be set in advance by the administrator or a specific user, and other sub-themes may be specified by the theme specifying unit 152 according to the content of the conversation and displayed.

For a talk room in which the talk theme is determined in advance, the theme specifying unit 152 may monitor whether the conversation according to the talk theme is continued. Alternatively, for the talk theme, the theme specifying unit 152 may specify a more detailed talk theme (lower-level talk theme). For example, when the talk theme determined in advance is “anime A”, the more detailed talk theme may be “character B in anime A”. In this manner, the theme specifying unit 152 may specify the talk theme hierarchically.

In addition, for a talk room in which a talk theme is not determined in advance, the theme specifying unit 152 may initially specify a talk theme. Thereafter, the theme specifying unit 152 may monitor whether the conversation according to the initially specified talk theme is continued (including whether there has been a change in the talk theme), as in the case of the talk room in which the talk theme is determined in advance. In addition, also for a talk room in which a talk theme is not determined in advance, the theme specifying unit 152 may specify a talk theme hierarchically.

In this manner, the theme specifying unit 152 can cope with changes or details of the talk theme even in the same talk room. In other words, even if the talk theme is set in advance, the content may change depending on the expansion of the conversation. However, since the theme specifying unit 152 may specify a talk theme from the ongoing conversation, it is possible to present the user with an accurate talk theme in real time.

There are various methods for specifying the talk theme, and any method may be used. For example, the theme specifying unit 152 may specify the talk theme by using a keyword extracted by the keyword extraction unit 154, which will be described later. In this case, the theme specifying unit 152 may specify the keyword itself as a talk theme, may specify a combination or fusion of two or more keywords as a talk theme, or may derive a talk theme from one or more keywords.

Alternatively, the theme specifying unit 152 can input talk data or a keyword described later and output (generate) a talk theme by using artificial intelligence. Artificial intelligence can be realized by implementing a convolutional neural network obtained by machine learning. In machine learning, for example, by using performance data related to talk data or performance data related to a keyword described later, the weight of the convolutional neural network and the like may be learned so as to maximize the accuracy of the result of specifying the talk theme.

In addition, the talk theme specified by the theme specifying unit 152 does not always have to be a specific word, and may be a summary of the content of the conversation or a partial excerpt of the conversation. In addition, the theme specifying unit 152 may specify two or more talk themes (for example, two types of main talk theme and sub-talk theme) for one talk room. For example, two or more talk themes may have the hierarchical relationship described above therebetween.

The keyword extraction unit 154 may specify (extracts) a keyword based on the talk data (conversation-related input from each user) in the corresponding talk room for each currently formed talk room. Any keyword extraction method may be used. For example, a morphological analysis engine (for example, “MeCab”) may be used. The keyword extraction unit 154 may divide the character string related to the talk data into words by the morphological analysis engine to generate a word list (or segmentation data). Then, the keyword extraction unit 154 may determine whether the selected word in the word list matches the extraction conditions by referring to noun translation Tbl or proper noun translation Tbl. When the selected word matches the extraction conditions, the keyword extraction unit 154 may extract the selected word and output (extract) the selected word as a keyword. In addition, the keyword extraction unit 154 may extract text with a high appearance frequency and extract a keyword according to the weighting.

In this case, the keyword extraction unit 154 may specify the keyword by using various tables (denoted as “Tbl” in FIG. 20) shown in FIG. 20. In this case, various nouns are registered in the noun translation Tbl. In this case, a concept, Japanese reading, an alternative notation, a pictogram, and the like may be associated with each noun. For example, for the noun “cat”, “Cat” may be associated as a concept, “neko” may be associated as a Japanese pronunciation, and neko, chat, nuko, (=\hat{ }x\hat{ }=), and the like may be associated as alternative notations or pictograms. In addition, various proper nouns are registered in the proper noun translation Tbl. In this case, concepts, Japanese reading, alternative notations, notations in other languages, and the like may be associated with various proper nouns. In addition, the noun translation Tbl or the proper noun translation Tbl may be referred to for each locale ID. In addition, the noun translation Tbl and the proper noun translation Tbl may be reinforced so as to support new words or proper expressions. In addition, it is also possible to prepare a trend word Tbl with high priority in advance. In this case, a text corresponding to a word registered in advance as a trend word may be extracted as a keyword, or a high weighting may be given to the text. In addition, the trend word Tbl may include words that are popular among all users within 24 hours or top ranking words for the year. In addition, although the noun translation Tbl and the proper noun translation Tbl are mentioned above as various tables, tables for verbs, phrases, clauses, sentences, and the like may be used without being limited thereto. In this manner, by specifying a keyword using a table, it is possible to specify a single consolidated keyword even if there are variations in the expression method for each user. In addition, when using a table with multilingual notations, even if the conversation is held in Japanese, it is possible to specify the corresponding foreign language keyword and present the talk theme in the foreign language to the foreign language user.

An excluded word Tbl may correspond to excluded word (forbidden word) information in the user information storage unit 144. Excluded words may include words (eg, greetings) that should not be extracted as keywords in addition to forbidden words. The excluded word Tbl may be created by the administrator. In this case, the excluded word Tbl may be editable by a specific user, or may differ according to the attributes of the talk room. In addition, an individual UserTbl may correspond to the user ID and conversation information (locale ID, total distribution time) in the user information storage unit 144. TalkSessionTbl may correspond to data in the talk situation storage unit 142. A raw utterance log may correspond to the talk data in the talk situation storage unit 142. For example, the raw utterance log may include information of each item of time, talk ID, user ID, and text information obtained by converting the utterance content into text. A text chat log may correspond to the talk data in the talk situation storage unit 142. For example, the text chat log may include information of each item of time, talk ID, user ID, and text.

The keyword extraction unit 154 may write the extracted keyword to TalkThemeTbl to update TalkThemeTbl. In addition, in TalkThemeTbl, a user ID, keywords (including nouns, verbs, phrases, clauses, sentences, and the like), the number of utterances, and the appearance frequency may be stored for each talk ID. When the number of keywords extracted by the keyword extraction unit 154 is relatively large, the keywords may be converted into concepts through the noun translation Tbl and then narrowed down to a predetermined number (for example, three) of higher-rank concepts according to the frequency or number of times of the same concept. In this case, the theme specifying unit 152 can specify the talk theme based on a predetermined number of higher-rank concepts. In addition, in this case, the theme specifying unit 152 may specify the predetermined number of higher-rank concepts themselves as a talk theme, or may create a talk theme by combining the predetermined number of higher-rank concepts. The keyword extraction unit 154 may check whether the extracted keyword corresponds to the excluded word by using the excluded word Tbl.

The processing cycle (for example, the update cycle of TalkThemeTbl or TalkSessionTbl) of the keyword extraction process by the keyword extraction unit 154 is arbitrary, and may be set to a relatively short cycle for a talk room whose talk theme is likely to change similarly to the update cycle of the talk data. That is, the keyword extraction process by the keyword extraction unit 154 may be performed each time the talk data is updated. As a result, changes in the talk room can be detected relatively quickly while reducing the load related to data update processing. In this case, the talk data used for keyword extraction by the keyword extraction unit 154 may be refreshed (that is, once deleted) at fixed intervals (for example, about 10 minutes), or may always be maintained in a FIFO (first in first out) format for the most recent fixed period of time (for example, about 10 minutes).

The talk management unit 156 may manage the state of each talk room. For example, the talk management unit 156 may determine conversation establishment conditions for detecting a conversation that should form a talk room, which is a conversation that can occur naturally, for a talk room other than a specified talk room such as the space portion 70. The conversation establishment conditions may be, for example, arbitrary. For example, for specific talk content for which the start time is designated in advance, the conversation establishment conditions for the talk content may be satisfied when the start time arrives. In addition, for specific talk content for which the start time is not designated in advance, the conversation establishment conditions may be satisfied, for example, when the following exemplary conditional elements are satisfied.

(Conditional Element 1)

Two or more avatars have a predetermined positional relationship (or are located in the location with the first attribute).

(Conditional Element 2)

There are conversation-related inputs from two or more avatar users.

(Conditional Element 3)

Conditions that can be determined as a conversation state are satisfied based on the interval between utterances of two or more avatars, context, distance between two or more avatars (distance in the virtual space), line-of-sight relationship between two or more avatars, and the like.

In addition, the talk management unit 156 may determine that the conversation establishment conditions are satisfied when one user (avatar) and another user (avatar) start talking and the conversation continues for about three turns, for example. In addition, the conversation establishment conditions are not limited to the number of turns, and may be satisfied when there is an input of a conversation start instruction from one user (for example, a talk room is formed when a button on the user interface for opening a talk room is selected), or may be satisfied when one user goes to a predetermined position (for example, a talk room is formed when a user goes to the signboard shown in FIG. 11 or the table shown in FIG. 24).

The talk management unit 156 may set the region R1 with the first attribute and the region R2 with the second attribute when the conversation establishment conditions are satisfied.

In addition, the talk management unit 156 may determine talk room removal conditions. The talk room removal conditions may be satisfied, for example, when the end time specified in advance arrives, when the elapsed time specified in advance passes, when the number of avatars in the talk room falls below a predetermined number (for example, 1), or when the frequency of conversation in the talk room falls below a predetermined standard.

The avatar determination unit 158 may determine the moderator avatar M2 (predetermined avatar) in each talk room. That is, the avatar determination unit 158 may determine the moderator avatar M2 among the avatars associated with respective users having a conversation in one talk room.

The method of determining the moderator avatar M2 by the avatar determination unit 158 may be arbitrary. For example, in the examples shown in FIGS. 7 and 8, the avatar determination unit 158 may specify an avatar holding a poster, a leaflet, or the like as the moderator avatar M2. In addition, for a talk room reserved in advance, an avatar that has been applied as the moderator avatar M2 may be specified as the moderator avatar M2.

In addition, the avatar determination unit 158 may determine the moderator avatar M2 according to the conversation situation for a talk room that occurs naturally or a talk room which is reserved in advance and for which the moderator avatar M2 is not specified. For example, the avatar determination unit 158 may determine the avatar of the user with the highest frequency of utterances as the moderator avatar M2.

In addition, when one talk room is separated into a plurality of talk rooms, the avatar determination unit 158 may determine a new moderator avatar M2 for each talk room after separation in the same manner as in the case of a talk room that occurs naturally.

In addition, when two or more talk rooms are merged, the avatar determination unit 158 may determine one or more moderator avatars M2, among the moderator avatars M2 of the talk rooms before merging, as new moderator avatars M2 for a talk room after merging. For example, when two or more talk rooms are merged, the avatar determination unit 158 may determine the moderator avatar M2 whose talk room before merging is the largest (for example, the number of participating avatars M1 in the region R1 with the first attribute is the largest) as a new moderator avatar M2.

In addition, the avatar determination unit 158 may determine the moderator avatar M2 in cooperation with the theme specifying unit 152. For example, an avatar with a high utterance frequency of a keyword related to the talk theme specified by the theme specifying unit 152 may be determined as the moderator avatar M2. In this case, since the moderator avatar M2 is an avatar with a high utterance frequency of the keyword related to the talk theme specified by the theme specifying unit 152, the moderator avatar M2 associated with one talk room can change dynamically. In addition, as described above, even if an avatar holding a poster, a leaflet, or the like is specified as the moderator avatar M2, when avatars interested in the created talk theme gather, the association between the avatar holding a poster, a leaflet, or the like and the talk theme may be canceled (that is, the avatar holding a poster, a leaflet, or the like may not be the moderator avatar M2).

In addition, the avatar determination unit 158 may be omitted when there is no need to determine the moderator avatar M2. In addition, the avatar determination unit 158 does not have to function for a talk room for which it is not necessary to determine the moderator avatar M2.

The distribution processing unit 160 may distribute one or more specific talk contents. In addition, as described above with reference to FIG. 13 or 15, the distribution processing unit 160 may output list information including distribution items of specific talk content being distributed or scheduled to be distributed.

The setting processing unit 162 may position each talk room (an example of a predetermined location or region) in the virtual space. Positioning of the talk room in the virtual space may be realized by setting the range of the talk room or the coordinate values (location) of the center location, for example. For example, the setting processing unit 162 may position the talk room in the virtual space by setting a plurality of space portions 70 for talk rooms as described above with reference to FIG. 5. The form or size of the space portion 70 (that is, the form or size of the talk room) may be arbitrary, and the form may be determined according to the type of the talk, and the size may be determined according to scale such as the number of participating avatars M1.

In addition, the talk room associated with the talk room image H21 (see FIG. 14A) for viewing on a smartphone or the like may be located independently of the space portion 70 (space portion in the world type virtual space).

The setting processing unit 162 may position a talk room in the virtual space in such a manner that a talk room is formed for each talk ID in the talk situation storage unit 142 (that is, for each talk theme of the conversation currently in progress).

In addition, when a plurality of talk rooms are formed in a common virtual space, the setting processing unit 162 may change the distance between the talk rooms based on the relevance or dependency between the talk themes specified for the talk rooms. At this time, the distance between two talk rooms may become shorter as the relevance between the talk themes of the two talk rooms becomes higher. In addition, when there is dependency between the talk themes of two talk rooms (for example, when there is a relationship of higher and lower levels between hierarchically specified talk themes), the distance between the talk rooms may be shortened. This can cause changes in talk rooms, such as merging of talk rooms, and accordingly, it is possible to promote the expansion of interaction between users due to the changes in talk rooms. When two or more talk rooms are having conversations with similar talk themes, merging the talk rooms may make the conversations more lively, and such an effect can be expected. Alternatively, a talk room related to a lower-level theme may be nested within a talk room related to a higher-level talk theme.

In addition, the setting processing unit 162 may change the location of the talk room based on the change of the talk theme. That is, the setting processing unit 162 may change the location of the one talk room when the talk theme related to the one talk room changes. Therefore, for example, for two talk rooms, the distance between the talk rooms may become shorter as the relevance between the talk themes of the talk rooms becomes higher, and conversely, the distance between the talk rooms may become longer as the relevance between the talk themes of the talk rooms becomes lower.

In addition, the setting processing unit 162 may merge two or more talk rooms when the talk room merging conditions are satisfied, or may separate one talk room into two or more talk rooms when the talk room separation conditions are satisfied. The merging conditions and the separation conditions may be arbitrary, and talk rooms with the same or similar talk themes may be merged, talk rooms having a predetermined distance therebetween may be merged, or one talk room may be separated when a plurality of talk themes are specified in one talk room (that is, when one talk room is divided into groups and conversations on different themes occur individually). When the merging conditions or the separation conditions are satisfied, the merging or separation of the talk rooms may be realized when a notification proposing the merging or separation of the talk rooms is presented to the moderator avatar M2 and an instruction to accept the proposal is input, or may be realized when the notification of the proposal is presented to all the participating avatars M1 and approval is obtained by a majority vote.

In addition, the setting processing unit 162 may perform notification processing (for example, guidance for collaboration) to promote merging when there are two or more talk rooms with similar talk themes. This may similarly occur for distribution of specific talk content. In the case of distribution of specific talk content, it may not be noticed that other host side users have started distribution with a similar theme. According to this notification processing, other people can notice that they want to “get excited about the same topic”, so that it is possible to avoid collisions between host side users and to resolve conflicts between viewers (participant side users).

The user extraction unit 164 may extract a user to be guided. The user to be guided (synonymous with an avatar of a user to be guided) may be a user who is preferable to be guided to a specific talk room, a user who is desired to be guided to a specific talk room, or the like. The user extraction unit 164 may extract a user to be guided based on a guidance request input from the user, or automatically extract an avatar to be guided based on the movement of the avatar in the virtual space. For example, when an avatar presumed to be wandering around without finding a desired talk room is detected, the user extraction unit 164 may extract the avatar as an avatar to be guided.

When the user to be guided is extracted by the user extraction unit 164, the guidance processing unit 166 may determine (extracts) a talk room where a conversation is held on the guidance target talk theme, among a plurality of currently formed talk rooms (talk rooms in which the user to be guided can participate), for the user to be guided. That is, when a plurality of talk rooms are formed in a common virtual space, the guidance processing unit 166 may determine a guidance target talk theme, among a plurality of talk themes, for the user to be guided.

The guidance target talk theme may be determined based on information regarding the user (data in the user information storage unit 144). For example, the guidance processing unit 166 may determine the guidance target talk theme based on conversation information associated with the user to be guided. For example, the guidance processing unit 166 may determine, as a guidance target talk theme, a talk theme including a keyword that is relatively frequently included in the conversation information of the user to be guided. In addition, based on the keyword included in the conversation information of the user to be guided, the guidance processing unit 166 may determine, as a guidance target talk theme, a talk theme including keywords highly related to the keyword (for example, keywords that are subordinate concepts of the keyword).

In addition, the guidance processing unit 166 may determine the guidance target talk theme based on preference information associated with the user to be guided. For example, the guidance processing unit 166 may determine, as a guidance target talk theme, a talk theme including a keyword that matches the preference information of the user to be guided. In addition, for a user to be guided that is related to an avatar coming out of the space portion 70 in the form of an event venue such as a movie theater, the guidance processing unit 166 may determine the talk theme related to the event as a guidance target talk theme.

In addition, the guidance processing unit 166 may determine a plurality of guidance target talk themes for one user to be guided. In this case, the guidance processing unit 166 may give priority to the plurality of guidance target talk themes. For example, when a plurality of guidance target talk themes are determined for one user to be guided, the guidance processing unit 166 may give priority to the plurality of guidance target talk themes based on the friend information. In this case, giving priority may be realized in such a manner that a talk theme related to a talk room, in which there are many users who are friends with one user to be guided, is given higher priority.

In addition, when talk themes are managed in a hierarchical structure (for example, a tree structure) as will be described later, the guidance processing unit 166 may determine a talk theme on the upper side of the hierarchical structure as a first guidance target talk theme so that the talk theme can be traced in order from the upper side to the lower side of the hierarchical structure. For example, in the example shown in FIG. 22, talk theme A is “anime”, talk theme B is “blade of OO”, talk theme C is “fist of OO”, talk theme D is “character X appearing on the blade of OO”, and talk theme G is “about the battle between the character X appearing on the blade of OO and boss Y”. In this case, a four-level hierarchical structure (top, higher level, middle level, and lower level as high-level categories) is obtained. In this case, when it is determined that one user to be guided is interested in anime based on the information regarding the user, the guidance processing unit 166 may determine the talk theme A “anime” as a first guidance target talk theme.

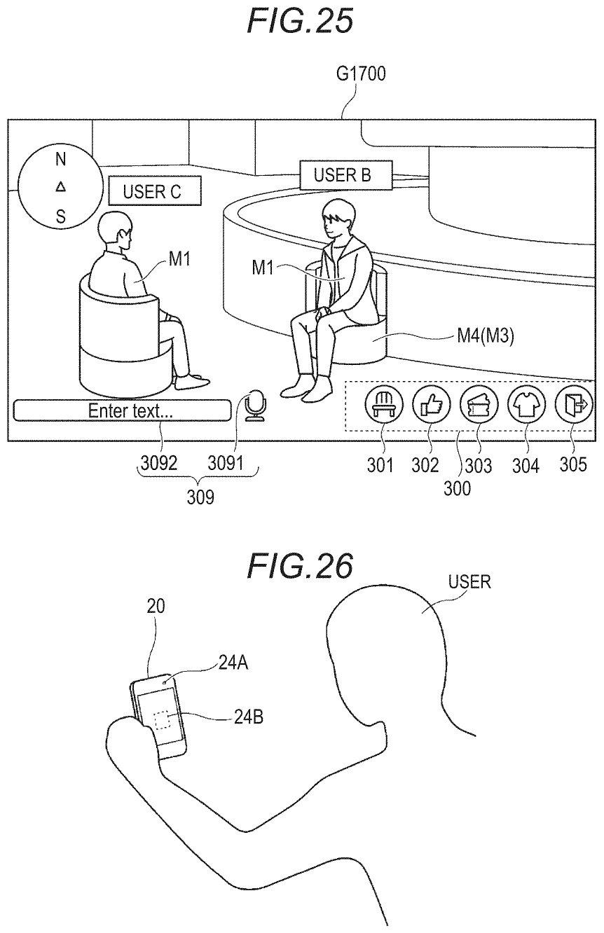

When the guidance target talk theme is determined for one user to be guided, the guidance processing unit 166 may perform guidance processing so that the avatar associated with the one user to be guided (hereinafter, also referred to as a “guidance target avatar M5”) can easily reach the talk room associated with the guidance target talk theme (hereinafter, also referred to as a “guidance target talk room”). The guidance processing may be realized in cooperation with the terminal apparatus 20 of the one user to be guided, as will be described later. For example, in the guidance processing, the guidance target talk theme or the talk room related to the talk theme may be linked to the “recommended” category (see FIG. 15), so that the guidance target talk theme or the talk room related to the talk theme is more visible to the user to be guided. Alternatively, a display medium (for example, the display medium 302R in FIG. 3) or a theme display (for example, the theme display G1302 in FIG. 13) showing the guidance target talk theme may be emphasized more than others. As the specification of emphasis, for example, changing the color, enlarging the text, enlarging the picture, and attaching a recommendation mark may be applied. Another example of guidance processing related to the guidance target talk theme will be described later with reference to FIG. 25.

In addition, when a plurality of guidance target talk themes are determined for one user to be guided, the guidance processing unit 166 may perform guidance processing so that the guidance target avatar M5 can easily reach the guidance target talk room in order of priority. In addition, when talk themes are managed in a hierarchical structure (for example, a tree structure) as will be described later, the guidance processing unit 166 may perform guidance processing for making it easier for the guidance target avatar M5 to reach the guidance target talk room, so that the talk theme can be traced in order from the upper side to the lower side of the hierarchical structure.

In addition, the guidance processing unit 166 may determine the guidance target talk theme based on other factors. For example, guidance to specific talk content hosted by the host side user may be promoted in response to the payment of consideration from the host side user. In this case, for example, the display medium showing a talk theme associated with the specific talk content may be made more noticeable than others. In addition, when there are similar talk themes competing with each other, the guidance processing unit 166 may determine the guidance target talk theme based on such factors.

In addition, the guidance processing unit 166 may perform auxiliary guidance processing by changing the display mode of the display medium showing a talk theme (see, for example, the display medium 302R in FIG. 3) or the theme display showing a talk theme (see, for example, the theme display G1302 in FIG. 13) in cooperation with a theme information output processing unit 256 of the terminal apparatus 20, which will be described later. For example, the theme information output processing unit 256 may change the visibility of the display medium showing a talk theme based on the preference information or the like of one user to be guided. In this case, the theme information output processing unit 256 may change the visibility of the display medium showing a talk theme so that the talk theme that matches the user's preference stands out.

When a plurality of conversations with different talk themes are established in the virtual space, the theme management unit 168 may manage the plurality of talk themes in a hierarchical structure in which the plurality of talk themes are hierarchically branched, as described above with reference to FIG. 22. Therefore, it is possible to realize the above-described guidance processing of the guidance processing unit 166 along the hierarchical structure.

The parameter calculation unit 170 may calculate the value of an activity level parameter (an example of a predetermined parameter) indicating the activity level of conversation in the talk room (that is, the activity level of the talk room). The parameter calculation unit 170 may calculate the activity level parameter for one talk room based on the number (total number) of participating avatars M1 related to the one talking room, the utterance frequency of each participating avatar, and the like. In this case, the value of the activity level parameter may be calculated in such a manner that the activity level increases as the number of participating avatars M1 increases or as the utterance frequency increases. In addition, the parameter calculation unit 170 may calculate the activity level parameter based on the number (total number) of participating avatars M1 per unit time.

In addition, for talk rooms where gifts can be given, the parameter calculation unit 170 may calculate (or correct) the value of the activity level parameter further based on the number or frequency of gift objects (see, for example, heart-shaped gift objects G12 in FIG. 14A). This also applies to comments (comments from the participant side user) having the same properties as gifts. In addition, when the volume information of each user's utterance can be acquired, the parameter calculation unit 170 may calculate the value of the activity level parameter in such a manner that the activity level increases as the volume increases. In addition, the parameter calculation unit 170 may also calculate (or correct) the value of the activity level parameter based on the sound of applause, laughter, cheers, or the like.

In addition, the parameter calculation unit 170 may calculate (or correct) the value of the activity level parameter based on non-verbal information such as the motion of the avatar in the conversation. For example, the parameter calculation unit 170 may calculate the value of the activity level parameter, based on the frequency of nodding movements of the user, in such a manner that the activity level increases as the frequency of nodding of the user increases.

In addition, the parameter calculation unit 170 may correct the value of the activity level parameter for one talk room according to the presence or absence of a specific avatar (for example, an avatar of an influencer or a celebrity).

After calculating the value of the activity level parameter for one talk room, the parameter calculation unit 170 may update the data in the talk situation storage unit 142 based on the calculated value. In addition, the data related to the activity level parameter in the talk situation storage unit 142 may be stored as time-series data. In this case, it is also possible to consider changes in activity levels or trends (upward trend or downward trend and the like). In addition, the timing of activity level parameter calculation by the parameter calculation unit 170 for one talk room is arbitrary, and the activity level parameter calculation may be performed at predetermined periods or may be performed when the number of participating avatars M1 changes.

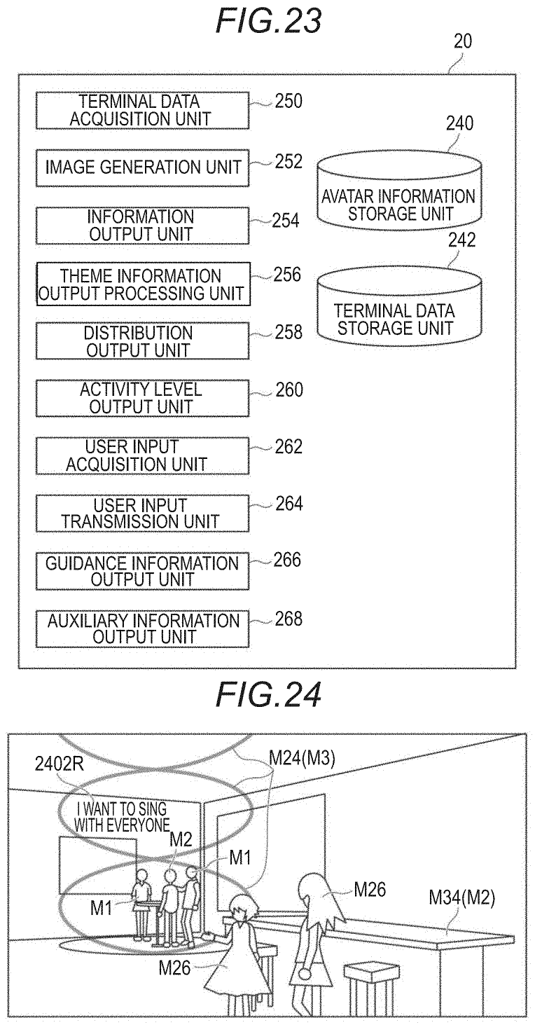

The terminal data acquisition unit 172 may acquire various kinds of data for each terminal apparatus 20 so that each terminal apparatus 20 can implement various functions described below with reference to FIGS. 23 to 27. The various kinds of data may include data in the talk situation storage unit 142, data indicating the states (locations or movements) of various avatars, data of text information or voice information related to various conversations, and the like. In addition, the data indicating the states (locations or movements) of various avatars may include motion information or location information (coordinates in the virtual space) of each avatar.

The terminal data transmission unit 174 may transmit various kinds of data acquired by the terminal data acquisition unit 172 to each terminal apparatus 20. Some or all of the transmission data to be transmitted to each terminal apparatus 20 may differ for each terminal apparatus 20 or may be the same. For example, only data related to a talk room in which the avatar of one user is present, among the data in the talk situation storage unit 142, the data indicating the states of various avatars, and the like, may be transmitted to the terminal apparatus 20 of one user. Further details of the transmission data will be described in connection with the description given below with reference to FIGS. 23 to 27.

The conversation support processing unit 176 may perform support processing for supporting various conversations in the talk room. The support processing is arbitrary. For example, digital content that matches the keyword in the conversation or the talk theme of the talk room may be specified and played on the display in the talk room (see, for example, the wall-mounted display object M10 in FIG. 10). For example, in the case of a conversation about a specific video, the specific video is played. Such specification of digital content (digital content that matches the keyword in the conversation or the talk theme of the talk room) may be realized on the terminal apparatus 20 side.

Next, functions of the terminal apparatus 20 will be mainly described with reference to FIGS. 23 to 27.

FIG. 23 is a schematic block diagram showing the functions of the terminal apparatus 20 related to the talk theme described above.

Although the following description will be mainly given for one terminal apparatus 20, this may be substantially the same for other terminal apparatuses 20. In addition, hereinafter, a user who uses one terminal apparatus 20 as a description target and an avatar of the user are also referred to as a self-user and a self-avatar, and users other than the user who uses one terminal apparatus 20 and their avatars are also referred to as other users and other avatars.

As shown in FIG. 23, the terminal apparatus 20 may include an avatar information storage unit 240, a terminal data storage unit 242, a terminal data acquisition unit 250, an image generation unit 252, an information output unit 254, a theme information output processing unit 256, a distribution output unit 258, an activity level output unit 260, a user input acquisition unit 262, a user input transmission unit 264, a guidance information output unit 266, and an auxiliary information output unit 268.

In addition, in FIG. 23, the avatar information storage unit 240 and the terminal data storage unit 242 can be realized by the terminal storage unit 22 of the terminal apparatus 20 shown in FIG. 1. In addition, the functions of the respective units of the terminal data acquisition unit 250 to the auxiliary information output unit 268 can be realized by the terminal control unit 25 or the terminal communication unit 21 of the terminal apparatus 20 shown in FIG. 1. Each of the above units may be implemented by, for example, a circuit element of the terminal apparatus 20; for example, an avatar information storage unit 240 may be implemented in memory hardware of the terminal apparatus 20.

The avatar information storage unit 240 may store avatar information acquired by the terminal data acquisition unit 250, which will be described later. The avatar information may correspond to some or all of the data in the avatar information storage unit 146 of the server apparatus 10 shown in FIG. 21.

The terminal data storage unit 242 may store terminal data acquired by the terminal data acquisition unit 250, which will be described later. The terminal data may be data necessary for the processing of the image generation unit 252, the information output unit 254, the theme information output processing unit 256, the distribution output unit 258, and the activity level output unit 260, which will be described later.

The terminal data acquisition unit 250 may acquire terminal data based on the transmission data transmitted from the terminal data transmission unit 174 of the server apparatus 10. The terminal data acquisition unit 250 may update the data in the terminal data storage unit 242 based on the acquired terminal data. In addition, the acquisition timing of the terminal data is arbitrary, and dynamically changeable data among the pieces of terminal data may be acquired at predetermined periods, or may be implemented in a push type or a pull type. For example, among the pieces of terminal data, data indicating the state (location or movement) of the avatar or data related to text information or voice information regarding the conversation may be acquired at predetermined periods. On the other hand, among the pieces of terminal data, basic data of the virtual space such as the second object M3 may be updated at relatively long periods.

The image generation unit 252 may generate a terminal image (an example of a terminal output image) showing the virtual space where the self-avatar is located. The image generation unit 252 may draw a portion of the virtual space excluding the avatar based on the data in the terminal data storage unit 242, for example. In this case, the viewpoint of the virtual camera related to the self-user (self-avatar) may be set and changed based on the user input from the self-user through the input unit 24. Then, when one or more other avatars (other avatars to be drawn) are located within the field of view of the virtual camera, the image generation unit 252 may draw one or more corresponding other avatars based on the avatar drawing information regarding the one or more corresponding other avatars, which is the data in the avatar information storage unit 146. In addition, the viewpoint of the virtual camera related to the self-user (self-avatar) may be the viewpoint of the eyes of the self-avatar, that is, the first person viewpoint (see FIG. 25) as a default. However, the viewpoint of the virtual camera may automatically change according to the state of the avatar, such as the third-person viewpoint while the avatar is moving and the first-person viewpoint (see FIG. 25) during conversation.

In addition, for example, when the moderator avatar M2 changes clothes (that is, when the ID related to hairstyle or clothes is changed), the image generation unit 252 may update the appearance of the moderator avatar M2 accordingly.

The image generation unit 252 may express changes in positions or movements of one or more other avatars based on information indicating the states (locations or movements) of one or more other avatars to be drawn, among the pieces of terminal data acquired by the terminal data acquisition unit 250. In addition, in the case of expressing the movements of the mouths or faces of other avatars when speaking, the image generation unit 252 may realize the expression in a manner synchronized with the voice information regarding the other avatars.

Specifically, for example, when other avatars within the field of view of the virtual camera related to the self-user are in the form of a character having a front facing direction, the image generation unit 252 may link the directions of other avatars with the directions of other users in such a manner that when the other users turn right, the corresponding other avatars turn right (or left), and when the other users look down, the corresponding other avatars look down. In addition, in this case, the direction may be only the face direction, may be only the body direction, or may be a combination thereof. In this case, the consistency (linkage) of directions between other avatars and other users is enhanced. Therefore, it is possible to diversify the expressions according to the directions of other avatars.

In addition, when other avatars are in the form of a character having a line-of-sight direction, the image generation unit 252 may link the line-of-sight directions of other avatars with the line-of-sight directions of other users in such a manner that when the lines of sight of the other users turn right, the lines of sight of the other avatars turn right (or left), and when the lines of sight of the other users turn downward, the lines of sight of the other avatars turn downward. In addition, various eye movements such as blinking may be linked. In addition, the movements of the nose, mouth, and the like may be linked. In this case, the consistency (linkage) of each part between other avatars and other users is enhanced. As a result, it is possible to diversify the facial expressions of other avatars.

In addition, when other avatars are in the form of a character having hands, the image generation unit 252 may link the movements of the hands of other avatars with the movements of the hands of other users in such a manner that when the other users raise their right hands, the other avatars raise their right hands (or left hands), and when the other users raise their both hands, the other avatars raise their both hands. In addition, the movement of each part of the hand such as fingers may also be linked. In addition, other parts such as feet may be linked in the same manner. In this case, the consistency (linkage) between other avatars and other users is enhanced. As a result, it is possible to diversify expressions by movements of parts of other avatars or the like.

In addition, in the present embodiment, the terminal image drawing process may be performed by the image generation unit 252 of the terminal apparatus 20. However, in other embodiments, a part or entirety of the terminal image drawing process may be performed by the server apparatus 10. For example, a part or entirety of the terminal image drawing process may be realized by the browser processing the HTML document received from the web server forming the server apparatus 10 or various programs (Javascript) attached thereto. That is, the server apparatus 10 may generate image generation data, and the terminal apparatus 20 may draw a terminal image based on the image generation data received from the server apparatus 10. In such a configuration, the terminal data acquisition unit 250 may acquire the image generation data from the server apparatus 10 each time. That is, temporary storage of various kinds of data required in the terminal apparatus 20 can be realized by a random access memory (RAM) forming the terminal storage unit 22 of the terminal apparatus 20. Various kinds of data may be loaded to the RAM and temporarily stored. In this case, for example, based on the HTML document created in the server apparatus 10, various kinds of data may be downloaded and temporarily loaded to the RAM to be used for processing (drawing and the like) in the browser. When the browser is closed, the data loaded to the RAM is erased. In addition, in another modification example, the terminal image may be output in a streaming format based on the image data generated by the server apparatus 10.

The information output unit 254 may output voice information or text information that can be viewed by the self-user together with the terminal image generated by the image generation unit 252 based on conversation-related input from each user associated with each avatar in the virtual space. In this case, the information output unit 254 may determine output destination users of the text information or voice information regarding conversations based on the positional relationship between each talk room in the virtual space and the location of the self-avatar. In this case, the output destination users of the text information or voice information regarding conversations in one talk room may include a user related to each avatar in the one talk room. In this manner, the information output unit 254 related to the self-user (and its terminal apparatus 20) may output voice information or text information that can be viewed by the self-user together with the terminal image only for the talk room in which the self-avatar is present among the talk rooms in the virtual space.

In addition, when the self-avatar is located in a talk room associated with the region R1 with the first attribute and the region R2 with the second attribute, the output mode of the text information or voice information regarding the conversation may be changed based on the positional relationship of the self-avatar with respect to the region R1 with the first attribute and the region R2 with the second attribute. Specifically, only when the self-avatar is located in the region R1 with the first attribute and the region R2 with the second attribute in one talk room, the information output unit 254 may output text information or voice information regarding the conversation in the one talk room to the terminal apparatus 20 of the self-user. In addition, when the self-avatar is located outside the region R2 with the second attribute in one talk room, the information output unit 254 may output voice information regarding the conversation in the one talk room to the terminal apparatus 20 of the self-user at a relatively low volume.

In addition, when the self-avatar is located in the free space portion 71, the information output unit 254 may output voice information regarding the conversation in the surrounding talk room to the terminal apparatus 20 of the self-user at a predetermined volume. The predetermined volume may be changed according to the current value of the activity level parameter of the corresponding talk room in such a manner that the predetermined volume increases as the activity level of the corresponding talk room increases.

In addition, for example, when one specific talk content is selected according to one user's input instruction on the selection screen described above with reference to FIG. 13 or 15, the information output unit 254 may output text information, voice information, or the like of the conversation related to the selected specific talk content to the terminal apparatus 20 of the one user, together with the terminal image, in cooperation with the distribution output unit 258. For example, in the example shown in FIG. 13, the information output unit 254 may output the text information, voice information, or the like of the conversation related to the specific talk content together with the talk room image H21 described above with reference to FIG. 14A.

The theme information output processing unit 256 may perform theme information output processing for making theme information indicating the talk theme specified by the theme specifying unit 152 of the server apparatus 10 be included in the terminal image. The output mode of the theme information may be arbitrary, and is the same as those described above with reference to FIGS. 9, 10, 11, 13, and 14, for example. For example, in the example shown in FIG. 10, assuming the avatar M7 about to enter the region R2 with the second attribute is a self-avatar, the theme information output processing unit 256 may draw the display medium 1002R on the terminal image (terminal image for the user related to the self-avatar) when the display medium 1002R including the text information of “talk theme A” is within the field of view from the virtual camera related to the self-avatar.

When the theme information output processing unit 256 may output a display medium (for example, the display medium 302R in FIG. 3) or a theme display (for example, the theme display G1302 in FIG. 13) showing a talk theme, the location or direction in the terminal image are, does not necessarily match the location or direction in the virtual space. For example, the display medium showing a talk theme may be output in the form of a signboard (always facing the front) as described above.

In addition, the theme information output processing unit 256 may change the display mode of the display medium showing a talk theme (see, for example, the display medium 302R in FIG. 3) or the theme display showing a talk theme (see, for example, the theme display G1302 in FIG. 13) based on the preference information, attribute information, or the like of the self-user. For example, based on the preference information of the self-user, the theme information output processing unit 256 may highlight a display medium showing a talk theme that the self-user likes, and conversely, may display a display medium showing a talk theme that the self-user dislikes in a small size or may not display the display medium showing a talk theme that the self-user dislikes.

The distribution output unit 258 may output the specific talk content selected by the self-user among the specific talk contents distributed by the distribution processing unit 160 of the server apparatus 10. In addition, drawing when outputting the specific talk content by the distribution output unit 258 may be realized in the same manner as the image generation unit 252.

Based on the activity level information (see FIG. 18) in the terminal data acquired by the terminal data acquisition unit 250, the activity level output unit 260 may include activity level information (information indicating the activity level of conversation) in the terminal image. The output mode of the activity level information may be arbitrary. For example, the current value of the activity level parameter may be output in a meter (gauge) representation.

Alternatively, the activity level output unit 260 may implement an output that indirectly may indicate the current value of the activity level parameter. For example, the activity level output unit 260 may generate various effects according to the current value of the activity level parameter. For example, as a “magic circle effect”, text information indicating the content of the utterance may be colored with a specific color for a predetermined object in the talk room, or rising particles may be generated in the text information indicating the content of the utterance. Particles may be expressed so as to rise within the virtual space, as schematically shown in FIG. 24. In this case, the effect may be generated in such a manner that the number of rising particle objects M24 (second objects M3) increases as the activation level increases. In addition, the particle object M24 may be generated with a specific change (for example, a rapid increase) in the value of the activity level parameter as a trigger.

In addition, the activity level output unit 260 may change the display mode (for example, the presence or absence of blinking or the thickness) of the line (circle) separating the region R1 with the first attribute and/or the region R2 with the second attribute according to the current value of the activity level parameter. In addition, the color of the line (circle) separating the region R1 with the first attribute and/or the region R2 with the second attribute may be selected by the user related to the moderator avatar M2, or may be automatically set for each talk theme or for each high-level category of talk theme, or may be set for each language (locale ID). In addition, FIG. 24 shows a display medium 2402R showing a talk theme. In this case, the display medium 2402R may be in the form of a character string floating above the heads of avatars having a conversation. For example, in the situation shown in FIG. 24, two avatars M26 standing and talking at a counter M34 arranged in a bar-like space portion can determine whether to participate in the conversation while viewing the display medium 2402R related to the conversation in which the particle object M24 rises.

In addition, the activity level output unit 260 may associate a highly active talk room with a tag “actively talking”, and conversely, may associate a quiet talk room with a tag “relaxedly talking”.

The user input acquisition unit 262 may acquire various inputs from the self-user through the input unit 24 of the terminal apparatus 20. The input unit 24 may be implemented by, for example, a user interface formed on a terminal image for the self-user.

FIG. 25 is a diagram showing an example of a user interface suitable for a world type virtual space where avatars can freely move around. FIG. 25 shows a terminal image G1700 in a state of conversing with other avatars (in this case, avatars of users B and C) from the first-person viewpoint of the self-avatar.

In the example shown in FIG. 25, the user interface may include a main interface 300, and the main interface 300 may include a chair button 301, a like button 302, a ticket management button 303, a friend management button 304, and an expel button 305. In addition, in the example shown in FIG. 25, the terminal image may include a conversation interface 309 that is another user interface.

The chair button 301 is operated when switching the state of the participating avatar M1 between a seated state and a non-seated state. For example, each user can generate a seating instruction to sit on a chair M4 by operating the chair button 301 when the user desires to talk carefully through the participating avatar M1. In addition, in FIG. 25, the avatars M1 of the users B and C are seated on the chair M4.

For example, when the chair button 301 is operated while the participating avatar M1 is in a seated state, a release instruction is generated. In this case, the chair button 301 may generate different instructions (seating instruction or release instruction) depending on whether the participating avatar M1 is in a seated state or in a movable state (for example, non-seated state). In addition, when the participating avatar M1 is in a seated state, the same effect as when the participating avatar M1 is located in the region R1 with the first attribute may be realized.

The form of the chair button 301 is arbitrary. In the example shown in FIG. 25, the chair button 301 has a chair form. In this case, it is possible to realize an intuitive and easy-to-understand user interface. In addition, the chair button 301 may be operable only when the self-avatar is located in a specific space such as the free space portion 71.

In addition, the chair button 301 related to one participating avatar M1 may be drawn differently between when the one participating avatar M1 is in a seated state and when the one participating avatar M1 is in a movable state. For example, the color, shape, and the like of the chair button 301 may be different between when the one participating avatar M1 is in a seated state and when the one participating avatar M1 is in a movable state. Alternatively, in a modification example, a seating instruction button and a release instruction button may be drawn separately. In this case, the seating instruction button may be drawn so as to be operable when the participating avatar M1 is in a movable state, and may be drawn so as to be inoperable when the participating avatar M1 is in a seated state. In addition, the release instruction button may be drawn so as to be inoperable when the participating avatar M1 is in a movable state, and may be drawn so as to be operable when the participating avatar M1 is in a seated state.

The like button 302 is operated when giving a good evaluation, a gift, or the like to another participating avatar M1 through the participating avatar M1.

The ticket management button 303 may be operated when outputting a ticket management screen (not shown) on which various states of tickets can be viewed. A ticket may be a virtual reality medium that should be presented when entering the specific space portion 70 (for example, a talk room for specific paid talk content).

The friend management button 304 may be operated when outputting a friend management screen (not shown) related to other participating avatars M1 with which the user is in a friend relationship.

The expel button 305 may be operated when expelling the participating avatar M1 from the virtual space or talk room.

The conversation interface 309 may be an input interface for conversation-related inputs implemented in the form of text and/or voice chat. In this case, the user can input voice by operating a microphone icon 3091 to speak (voice input from the input unit 24 in the form of a microphone), and can input text by inputting text in a text input region 3092. This allows users to have a conversation with each other. In addition, the text may be drawn on each terminal image (each terminal image related to each of users in conversation) in an interactive format in which a predetermined number of histories remain. In this case, for example, the text may be output separately from the image related to the virtual space, or may be output so as to be superimposed on the image related to the virtual space.

In addition, when a self-avatar is located in the talk room having the region R1 with the first attribute and the region R2 with the second attribute as described above, the conversation interface 309 may be activated (or displayed) only when the self-avatar is located in the region R1 with the first attribute. In addition, the icon 3091 may be mutable according to the operation of the self-user. Even in this case, the self-user can have a conversation with other users through text input.

FIG. 26 is an explanatory diagram of a part direction operation input by a gesture. FIG. 26 shows how the self-user may perform a part direction operation input by changing the direction of the face while holding the terminal apparatus 20 with his or her hand. In this case, the terminal apparatus 20 may specify the face of the self-user based on the face image of the self-user input through a terminal camera 24A, and may generate operation input information including a part direction operation input according to the specified face direction. Alternatively, the self-user may change the direction of the terminal apparatus 20 while holding the terminal apparatus 20 with his or her hand. In this case, the terminal apparatus 20 may generate operation input information including a part direction operation input according to the direction of the terminal apparatus 20 based on an acceleration sensor 24B built into the terminal apparatus 20.

The operation input by gestures may be used to change the viewpoint of the virtual camera. For example, when the self-user changes the direction of the terminal apparatus 20 while holding the terminal apparatus 20 with his or her hand, the viewpoint of the virtual camera may be changed according to the direction. In this case, even if the terminal apparatus 20 with a relatively small screen, such as a smartphone, is used, it is possible to ensure a wide viewing area in the same manner as when the surroundings can be viewed through a head-mounted display.

The user input transmission unit 264 may transmit various user inputs described above acquired by the user input acquisition unit 262 to the server apparatus 10. The data based on some or all of the various user inputs from the self-user transmitted to the server apparatus 10 as described above can be acquired through the server apparatus 10, as terminal data for the terminal apparatuses 20 of other users, by the terminal data acquisition units 250 of the terminal apparatuses 20 of the other users. In addition, in a modification example, data exchange using P2P may be realized between the terminal apparatus 20 of the self-user and the terminal apparatuses 20 of other users.

The guidance information output unit 266 functions when the self-user is extracted as a user to be guided. That is, the guidance information output unit 266 functions when the self-avatar may become the guidance target avatar M5. The guidance information output unit 266 may perform guidance processing for making it easier for the self-avatar (guidance target avatar M5) to reach the guidance target talk room in cooperation with the guidance processing unit 166 of the server apparatus 10.

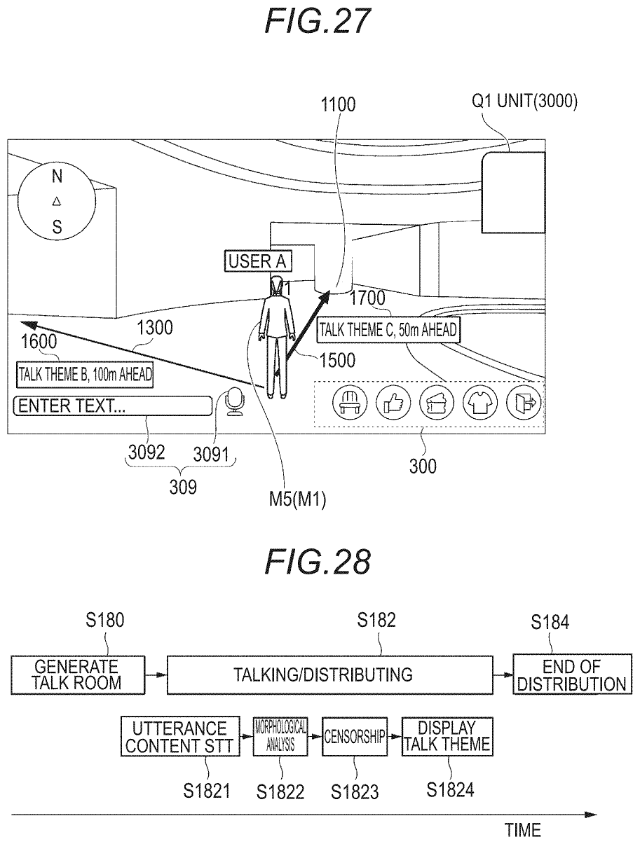

FIG. 27 is a diagram showing an example of a terminal image for a user in order to explain an example of guidance processing. In addition, the guidance processing shown in FIG. 27 may be suitable for a world type virtual space where avatars can freely move around.

In FIG. 27, arrow lines 1300 and 1500 may be drawn as guidance information in association with a self-avatar (guidance target avatar M5). In this case, the guidance information output unit 266 may calculate a guidance route, which is a recommended route for moving to the guidance target talk room, based on the positional relationship between the guidance target avatar M5 and the guidance target talk room. At this time, the guidance information output unit 266 may calculate a guidance route (that is, a guidance route along which the guidance target avatar M5 can move) that does not pass through objects related to obstacles, such as impassable objects. Based on the calculated guidance route, the guidance information output unit 266 may draw the arrow lines 1300 and 1500 along the guidance route as shown in FIG. 27 and may draw talk theme guidance information 1600 and 1700 (theme information). Therefore, the user related to the guidance target avatar M5 can easily understand that a talk room related to a talk theme B can be reached by moving along the arrow line 1300, and can understand that the distance is 100 m. In addition, the user related to the guidance target avatar M5 can easily understand that a talk room related to a talk theme C can be reached by moving along the arrow line 1500, and can understand that the distance is 50 m. In addition, in FIG. 27, a warp area 1100 may be set, and the user can efficiently move to the talk room related to the talk theme C through the warp area 1100. In addition, such a warp area 1100 may appear when talk themes are managed in a hierarchical structure. In this case, the warp area 1100 may be set for each branch, or the user may determine the branch destination for each warp area 1100. In addition, the mode of guidance when talk themes are managed in a hierarchical structure is not limited to this, and a conceptual branch map may be presented, or a door (second object M3) may be set instead of the warp area 1100. In addition, the conceptual branch map may be in the form of a Sugoroku (Japanese board game) or a train route map.

In the example shown in FIG. 27, the information of the distance to the guidance target talk room is additionally output. However, in addition to or instead of this, the number of friend users in the guidance target talk room or activity level information may be output. In this case, the user can select a desired talk room from a plurality of guidance target talk rooms, taking into consideration not only the talk theme but also the distance, presence or absence of friends, and the like. In addition, the guidance information output unit 266 may guide interaction with a user other than friend users, who has many matching keywords related to the talk room in which they have participated in the past. For example, the guidance information output unit 266 may recommend making friends with a user who has many matching keywords related to the talk room in which they have participated in the past, or may move the user closer to a user, who has many matching keywords related to the talk room in which they have participated in the past, in the virtual space with a warp button (not shown) or the like. The display unit 23 of the terminal apparatus 20 of the user may be notified of “recommend making friends”. In addition, for the convenience of a beginner user who has never participated in a conversation, when the user selects one or more talk themes that the user desires to talk about, users who have participated in the conversation on the talk theme in the past may be extracted and the notification of “recommend making friends” and “move nearby” may be provided, or the talk room may be presented. As a result, even a user who does not have friends at the beginning can effectively make an opportunity to talk with strangers for the first time.

The auxiliary information output unit 268 may output various kinds of auxiliary information that are highly convenient for the user. For example, the auxiliary information output unit 268 may associate participation availability information (see data in the talk situation storage unit 142 in FIG. 18) with each talk room. For example, whether participation is possible or not may be presented on the door of the talk room (second object M3) or on the screen before participating in the conversation. For example, a message board (second object M3) such as “Allowed to enter!”, “Anyone can participate!”, and “Don't enter!” may be associated with each talk room. Alternatively, the auxiliary information output unit 268 may put the talk room in which participation is not possible into a locked state, or may make invisible the talk room in which participation is not possible. In this case, the auxiliary information output unit 268 may make it easier for the talk room in which the user can participate to enter the user's field of view (within the field of view of the virtual camera).

In addition, when the language of the conversation held in the talk room is different from the language of the self-user, the auxiliary information output unit 268 may output a translation (for example, in the form of subtitles) for text information or audio information regarding the conversation in synchronization with the output of the text information or the voice information.

In addition, the auxiliary information output unit 268 may present a talk theme for the second meeting at the end of the conversation based on a specific talk theme. In this case, the remaining users (participants) may determine the next theme. Alternatively, the auxiliary information output unit 268 may automatically propose the next talk theme candidate based on the previous conversation information. Alternatively, the auxiliary information output unit 268 may present a close talk theme from other existing conversation information.

Next, various operation examples in the virtual reality generation system 1 shown in FIG. 1 will be further described with reference to FIG. 28 and subsequent diagrams.

FIG. 28 is an explanatory diagram of the flow of operations from the generation of one talk room to the end of distribution. FIG. 28 schematically shows an exemplary flow of operations from the generation of one talk room to the end of distribution, with the horizontal axis as time.

First, in step S180, a talk room may be generated (formed). As described above, a talk room may be formed in response to a request (reservation or the like) from the host side user in the case of distribution of specific talk content or may be formed naturally by the flow of conversations between avatars in the case of a world type virtual space, and the conditions for forming a talk room are arbitrary. In addition, when the talk room is generated (formed), a talk ID may be assigned to the talk room, and the region R1 with the first attribute and the region R2 with the second attribute may be defined as appropriate.

When the talk room is generated (formed), the state of conversation/distribution in the talk room may be formed (S182). In such a state, various processes for specifying the talk theme may be performed. Specifically, the utterance content may be converted into text (denoted as “utterance content STT” in the diagram) (S1821), and the talk theme may be specified (and displayed) (S1824) through morphological analysis (S1822) and censorship (S1823). Then, when the talk room removal conditions are satisfied (for example, when the distribution end time comes), the distribution ends (S184). In the case of a world type virtual space, the talk room may be removed or may be opened for other uses instead of ending the distribution. In addition, when the conversation is based on text input through chatting or the like, the step of converting utterance content into text (“utterance content STT” in the diagram) (S1821) among the steps described above may be omitted.

Here, the conversion of utterance content into text (S1821) or morphological analysis (S1822) may be performed by the server apparatus 10, but this may also be performed by the terminal apparatus 20. In this case, the processing costs associated with various processes for specifying the talk theme can be distributed, and the load on the server apparatus 10 can be reduced. In addition, any applicable censorship (S1823) may be preferably performed by the server apparatus 10 in terms of management of various dictionaries such as the noun translation Tbl, but a part of the processing may be performed by the terminal apparatus 20. In addition, of the talk theme specification and display (S1824), the talk theme specification may be preferably performed by the server apparatus 10, but a part of the processing may be performed by the terminal apparatus 20. In addition, of the talk theme specification and display (S1824), the talk theme display (drawing) may be preferably performed by the terminal apparatus 20, but may be performed by the server apparatus 10 as well.

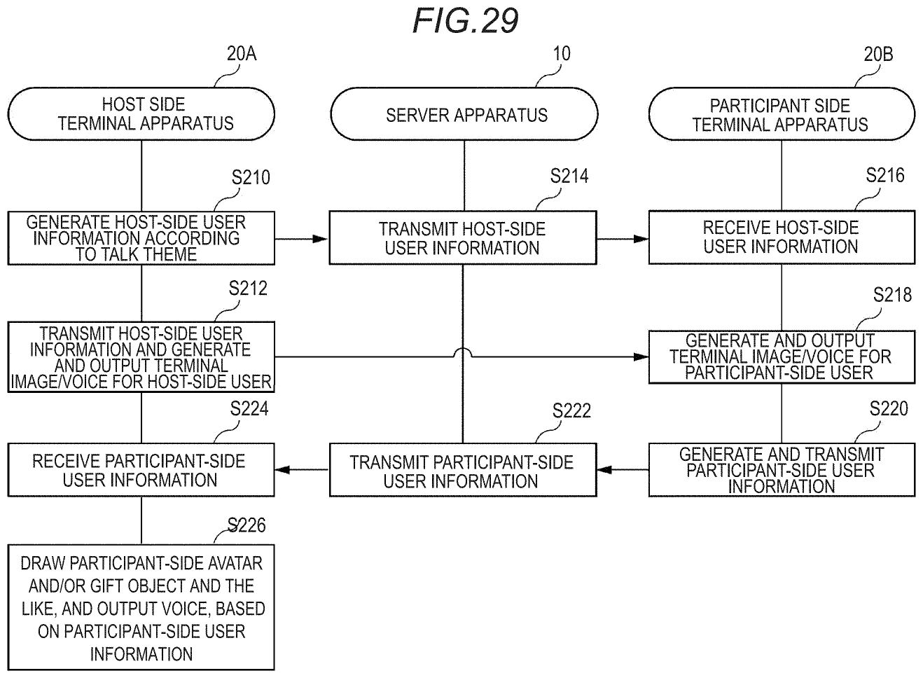

FIG. 29 is a flowchart showing an example of operations during the distribution of specific talk content by a host side user (that is, during the viewing of specific talk content by a participant side user), which are operations of the terminal apparatus 20A on the host side (content distribution side), the terminal apparatus 20B on the participant side (content viewing side), and the server apparatus 10 performed in the virtual reality generation system 1 shown in FIG. 1.

In FIG. 29, the left side shows the operations that may be performed by one host side terminal apparatus 20A, the center shows the operations that may be performed by the server apparatus 10 (here, one server apparatus 10), and the right side shows the operations that may be performed by one participant side terminal apparatus 20B.

In step S210, the host side user may start distribution according to the talk theme, and may perform various operations (including utterances related to conversation) to realize various operations of the moderator avatar M2. As a result, the host side terminal apparatus 20A may generate host side user information according to the various operations of the moderator avatar M2. The host side terminal apparatus 20A may transmit such host side user information to the server apparatus 10 as terminal data related to the terminal apparatus 20B. In addition, the host side user information may be multiplexed by any multiplexing method and transmitted to the server apparatus 10 as long as the condition that the correspondence between information to be transmitted (transmitted information) and the time stamp based on the reference time is clear in both the host side terminal apparatus 20A and the participant side terminal apparatus 20B is satisfied. When such a condition is satisfied, the participant side terminal apparatus 20B can appropriately process the host side user information according to the time stamp corresponding to the host side user information when the host side user information is received. As for the multiplexing method, the host side user information may be transmitted through separate channels, or some of the host side user information may be transmitted through the same channel. A channel may include timeslots, frequency bands, and/or spreading codes, and the like. In addition, the method of distributing videos (specific talk content) using the reference time may be implemented in the manner disclosed in JP6803485B, which is incorporated herein by reference.

Then, in parallel with the operation in step S210, in step S212, the host side terminal apparatus 20A may continuously transmit host side user information for drawing the talk room image H21 for the participant side user to the participant side terminal apparatus 20B through the server apparatus 10, and may output a talk room image (not shown) for the host side user to the host side terminal apparatus 20A.

The host side terminal apparatus 20A can perform the operations in steps S210 and S212 in parallel with the operations in steps S214 to S222 described below.

Then, in step S214, the server apparatus 10 may transmit (transfers) the host side user information, which is continuously transmitted from the host side terminal apparatus 20A, to the participant side terminal apparatus 20B.

In step S216, the participant side terminal apparatus 20B may receive the host side user information from the server apparatus 10 and may store the received host side user information in the terminal storage unit 22. In one embodiment, in consideration of the possibility that the amount of voice information may be larger than the amount of other information and/or the possibility of communication line failure, the participant side terminal apparatus 20B can temporarily store (buffer) the host side user information received from the server apparatus 10 in the terminal storage unit 22 (see FIG. 1).

In parallel with such reception and storage of the host side user information, in step S218, the participant side terminal apparatus 20B may generate the talk room image H21 for the participant side user by using the host side user information, which may be received from the host side terminal apparatus 20A through the server apparatus 10 and stored, to reproduce the specific talk content.

In parallel with the operations in steps S216 and S218, in step S220, the participant side terminal apparatus 20B may generate participant side user information and may transmit the participant side user information, as terminal data related to the terminal apparatus 20A, to the host side terminal apparatus 20A through the server apparatus 10. The participant side user information may be generated, for example, only when the participant side user inputs a conversation-related input or may perform an operation to give a gift.

In step S222, the server apparatus 10 may transmit (transfer) the participant side user information received from the participant side terminal apparatus 20B to the host side terminal apparatus 20A.

In step S224, the host side terminal apparatus 20A can receive the participant side user information through the server apparatus 10.

In step S226, the host side terminal apparatus 20A can basically perform the same operation as in step S210. For example, the host side terminal apparatus 20A may generate an instruction to draw the participating avatar M1 and/or a gift drawing instruction based on the participant side user information received in step S224, and may draw the corresponding participating avatar M1 and/or gift object on the talk room image. In addition, when a voice output instruction is generated in addition to the drawing instruction, drawing and voice output are performed.

In this manner, the process shown in FIG. 29 may be continuously performed until the host side user ends the distribution of the specific talk content or until there is no participant side user of the specific talk content.

In addition, in the example shown in FIG. 29, the execution subject of each process can be changed in various manners as described above. For example, among the processes of step S212, the process of generating a talk room image (not shown) for the host side user may be realized by the server apparatus 10 instead of the terminal apparatus 20A. In addition, among the processes of step S218, the process of generating the talk room image H21 for the participant side user may be realized by the terminal apparatus 20A or the server apparatus 10. In this case, in step S216, the data of the talk room image H21 for the participant side user may be received instead of the host side user information. In addition, among the processes of step S226, the process of drawing the gift object on the talk room image (not shown) for the host side user based on the participant side user information may be realized by the server apparatus 10 instead of the terminal apparatus 20A.

In addition, in the example shown in FIG. 29, the roles of the host side (content distribution side) and the participant side (content viewing side) are distinguished, but these roles may not be distinguished. For example, in a world type virtual space where each avatar can freely move around, as described above, the distinction between the roles of the participating avatar M1 and the moderator avatar M2 is for convenience of explanation, and there may be no substantial difference between avatars. That is, in the virtual space where each avatar can freely move around, each terminal image is an image showing the state of the virtual space from the viewpoint of each virtual camera. For this reason, there is no need to distinguish the roles.

While the embodiments have been described in detail with reference to the diagrams, the specific configuration is not limited to the various embodiments described above, and may include designs and the like within the scope of the invention.

For example, in the embodiments described above, each user can freely participate in the talk room, but the talk room in which each user can participate may differ depending on the attributes of the user, or a special talk room, such as a private talk room, may be set. For the special talk room such as a private talk room, the talk theme does not have to be specified, and even if the talk theme is specified, the output of a theme display (theme information) or the like showing the corresponding talk theme may be prohibited. Therefore, a display medium or the like showing a talk theme may be output only for a talk room in which each user can freely participate.

In addition, in the embodiments described above, it may be possible to fix the language in the talk room in response to a request from the host of an official event or the like. In this case, when utterances in different languages are detected, a notification or the like regarding language-related cautions may be provided.

In addition, in the embodiments described above, the talk theme associated with one talk room can change according to the specification result of the theme specifying unit 152, but such changes may be prohibited, for example, based on a request or setting from the host side user. In this case, even if the host side user deliberately derails the theme during the conversation, it is possible to prevent the talk theme from changing due to the derailment.

In addition, in the embodiments described above, for example, the following modifications may be applied.

It may be determined whether the display medium 302R (for example, a signboard) displaying the talk theme is within the field of view of other users, and an event hook or log is created to measure advertising effectiveness.

In order to increase the size of the display medium 302R (for example, a signboard) displaying the talk theme and make it easier to see the display medium 302R for incentives for paying users and the like, the display medium 302R may be highlighted by animation, illumination, and the like. In addition, when the display medium 302R is configured as a signboard, the signboard may normally be arranged at a fixed location. In this case, however, the signboard may not stand out well due to the relationship with other elements in the virtual space. In such a case, in order to make the signboard stand out in the same manner as the signboard in the real space and to improve the visibility of the signboard itself, a function called “decoration” may be added to the signboard for the talk theme. As specific examples of the decoration function, as described above, the installation size (area) of the signboard may be increased, the information surface of the signboard may be animated (any URL such as YouTube or video file may be added and displayed within the signboard), or an effect such as illumination may be added around the information. In addition, when performing a search with a search function (for example, “magnifying glass emoji”) instead of in the virtual space, it may be possible to display information and images of this event including the talk theme with a specific keyword at the time of searching (function similar to “listing advertisement (search-linked advertisement)”). In addition, when such a decoration function is added, an additional charge may be set.

Participants of the talk theme may be notified that the display medium 302R (for example, a signboard) displaying the talk theme has entered the field of view of another user and that another user has approached the circle.

By the above notification, the directions of the participating avatars may be automatically changed to the direction of another user, and the emotes may be automatically reproduced. The emote is a function that makes an avatar take a pose (behavior) determined for each emotional expression. Here, for example, participating avatars may “clap” or send a “peace” sign in the direction of another user who is approaching, all at once or individually. In addition to this, for example, it is possible to ask for a “handshake” or pose such as “beckoning” or “hug”. On the other hand, when another user leaves the circle, the participating avatars may wave their hands to say “bye-bye”, put their hands together to say “sorry”, or raise their hands to say “see you later”. In addition, the same pose may be perceived differently depending on the country (for example, a pose that is harmless in one country may be perceived as an insulting pose in another country). Therefore, for each nationality of other users, consideration may be given to appropriately correspond to the emotional expression at that time.

For the automatic emote, the attributes of other users may be classified according to tags such as “beginner”, “looking for someone to talk to”, “don't want to talk”, topics, language attributes, and the like.

The automatic emote may depend on the current activity level of the conversation of the talk room.

### REFERENCE SIGNS LIST

1 virtual reality generation system
3 network
10 server apparatus
11 server communication unit
12 server storage unit
13 server control unit
20 terminal apparatus
21 terminal communication unit
22 terminal storage unit
23 display unit
24 input unit
24A terminal camera
24B acceleration sensor
25 terminal control unit
30 studio unit
70 space portion
71 free space portion
140 talk history storage unit
142 talk situation storage unit
144 user information storage unit
146 avatar information storage unit
150 talk data acquisition unit
152 theme specifying unit
154 keyword extraction unit
156 talk management unit
158 avatar determination unit
160 distribution processing unit
162 setting processing unit
164 user extraction unit
166 guidance processing unit
168 theme management unit
170 parameter calculation unit
172 terminal data acquisition unit
174 terminal data transmission unit
176 conversation support processing unit
240 avatar information storage unit
242 terminal data storage unit
250 terminal data acquisition unit
252 image generation unit
254 information output unit
256 theme information output processing unit
258 distribution output unit
260 activity level output unit
262 user input acquisition unit
264 user input transmission unit
266 guidance information output unit
268 auxiliary information output unit

1. An information processing system, comprising a memory and processing circuitry, the processing circuitry configured to:
generate a terminal output image showing a virtual space including an avatar associated with each user;
output text information or voice information perceptible by each user together with the terminal output image based on a conversation-related input from each user associated with an avatar in the virtual space;
specify, for a conversation established between users based on the text information or the voice information, a theme of the conversation based on the conversation-related input; and
output theme information indicating the theme of the conversation be included in the terminal output image.

2. The information processing system according to claim 1,
wherein the processing circuitry is further configured to determine a method of outputting the theme information for one user based on user information regarding the one user.

3. The information processing system according to claim 1,
wherein the processing circuitry is further configured to, upon the conversation for which the theme information is output being selected in response to an input instruction from one user, output the text information or the voice information of the selected conversation to the one user.

4. The information processing system according to claim 1, wherein the processing circuitry is further configured to:
distribute one or more predetermined digital contents and output list information including distribution items of the predetermined digital contents being distributed or scheduled to be distributed, and
associate the theme information indicating the theme of the conversation related to the predetermined digital contents with the list information.

5. The information processing system according to claim 4,
wherein the processing circuitry is further configured to output the distribution items of the predetermined digital contents in a manner including a corresponding thumbnail.

6. The information processing system according to claim 4,
wherein the processing circuitry is further configured to, upon selection of one of the predetermined digital contents in response to an input instruction from one user, output the text information or the voice information of the conversation related to the selected one predetermined digital content to the one user.

7. The information processing system according to claim 1,
wherein the processing circuitry is further configured to determine an output destination user of the text information or the voice information of the conversation based on a positional relationship between a predetermined location or region associated with the theme of the conversation and a location of each avatar in the virtual space.

8. The information processing system according to claim 7,
wherein the processing circuitry is further configured to associate a predetermined display medium related to the theme information with the predetermined location or region.

9. The information processing system according to claim 7, wherein the processing circuitry is further configured to determine a predetermined avatar among avatars associated with users who establish the conversation, and
is further configured to associate a predetermined display medium related to the theme information with the predetermined avatar.

10. The information processing system according to claim 7,
wherein the predetermined location or region associated with the theme of the conversation includes a location or region with a first attribute and a location or region with a second attribute different from the first attribute, and
wherein the processing circuitry is further configured to output the text information or the voice information to each user associated with one or more avatars located in the predetermined location or region based on the conversation-related inputs only from users associated with one or more avatars located in the location or region with the first attribute among users associated with one or more avatars located in the predetermined position or region.

11. The information processing system according to claim 10,
wherein the location or region with the second attribute is set adjacent to the location or region with the first attribute.

12. The information processing system according to claim 7, wherein the processing circuitry is further configured to, upon specification of the theme of the conversation, associate the predetermined location or region with the theme of the conversation.

13. The information processing system according to claim 12,
wherein the processing circuitry is further configured to, upon specification of a plurality of conversations with a plurality of different themes, associate a plurality of predetermined locations or regions with the plurality of different themes; and
is further configured to change a distance between the predetermined locations or regions associated with each theme in the plurality of different themes based on relevance or dependency between the conversation themes.

14. The information processing system according to claim 12,
wherein the processing circuitry is further configured to monitor presence or absence of a change in the theme of the conversation.

15. The information processing system according to claim 14,
wherein the processing circuitry is further configured to change the predetermined location or region based on the change in the theme of the conversation.

16. The information processing system according to claim 7, wherein:
the memory stores conversation information regarding the conversation in which each user has participated so as to be associated with each user;
wherein the processing circuitry is further configured to extract a user to be guided; and
determine a guidance target theme for the user to be guided, among themes of a plurality of the conversations, based on the conversation information associated with the user to be guided when the plurality of conversations with different themes are established in the virtual space.

17. The information processing system according to claim 16, wherein the processing circuitry is further configured to:
manage, upon establishment of a plurality of the conversations having different themes in the virtual space, the themes of the plurality of conversations in a hierarchical structure in which the themes of the conversations are hierarchically branched, and
determine a theme on an upper side of the hierarchical structure as a first guidance target theme so that the one user to be guided traces the hierarchical structure in order from the upper side to a lower side.

18. The information processing system according to claim 1, wherein the processing circuitry is further configured to:
extract a keyword based on the conversation-related input from each user.

19. The information processing system according to claim 1, wherein the processing circuitry is further configured to:
calculate a value of a predetermined parameter indicating an activity level of the conversation; and
make information indicating the activity level of the conversation be included in the terminal output image based on the calculated value of the predetermined parameter.

20. An information processing method executed by a computer, comprising:
generating a terminal output image showing a virtual space including an avatar associated with each user;
outputting text information or voice information perceptible by each user together with the terminal output image based on a conversation-related input from each user associated with an avatar in the virtual space;
specifying, for a conversation established between users based on the output text information or the output voice information, a theme of the conversation based on the conversation-related input; and
making theme information indicating the specified theme of the conversation be included in the terminal output image.

21. A non-transitory computer-readable medium on which is provided program code that, when executed by a computer, causes the computer to execute steps of:
generating a terminal output image showing a virtual space including an avatar associated with each user;
outputting text information or voice information perceptible by each user together with the terminal output image based on a conversation-related input from each user associated with an avatar in the virtual space;
specifying, for a conversation established between users based on the output text information or the output voice information, a theme of the conversation based on the conversation-related input; and
making theme information indicating the specified theme of the conversation be included in the terminal output image.
